(19) United States
(12) Patent Application Publication
(10) Pub. No.: US 2026/0095209 A1
(43) Pub. Date: Apr. 2, 2026

(54) TRANSMISSIVE SURFACE ENABLED MULTI-LAYER COMMUNICATIONS

(71) Applicant: QUALCOMM Incorporated, San Diego, CA (US)

(72) Inventors: Narayan PRASAD, Westfield, NJ (US); Tao LUO, San Diego, CA (US); Junyi LI, Greentown, PA (US); Jorge FABREGA SANCHEZ, San Diego, CA (US); Allen Minh-Triet TRAN, Rancho Santa Fe, CA (US)

(21) Appl. No.: 18/901,463

(22) Filed: Sep. 30, 2024

(51) Int. Cl. H04B 7/04; H04W 24/02; H04W 76/20; H04W 92/18

(52) U.S. Cl. CPC H04B 7/04013; H04W 24/02; H04W 76/20; H04W 92/18

(57) ABSTRACT

Various aspects of the present disclosure generally relate to wireless communication. In some aspects, a first wireless communication device may transmit, to a second wireless communication device, coordination information associated with receiving a multi-layer communication from a network node via multiple transmissive surfaces. The first wireless communication device may receive the multi-layer communication from the network node via the multiple transmissive surfaces. Numerous other aspects are described.

### FIELD OF THE DISCLOSURE

Aspects of the present disclosure generally relate to wireless communication and specifically relate to techniques, apparatuses, and methods associated with transmissive surface enabled multi-layer communications.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (for example, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (for example, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

### SUMMARY

Some aspects described herein relate to a method of wireless communication performed by a first wireless communication device. The method may include transmitting, to a second wireless communication device, coordination information associated with receiving a multi-layer communication from a network node via multiple transmissive surfaces. The method may include receiving the multi-layer communication from the network node via the multiple transmissive surfaces.

Some aspects described herein relate to a method of wireless communication performed by a wireless communication device. The method may include transmitting, to a network node, information indicating an availability of multiple antenna modules for communicating uncorrelated streams via multiple transmissive surfaces. The method may include receiving a multi-layer communication from the network node via the multiple transmissive surfaces.

Some aspects described herein relate to a method of wireless communication performed by a wireless communication device. The method may include transmitting, to a network node, information indicating a rank denoting a quantity of uncorrelated streams that can be communicated via multiple transmissive surfaces. The method may include receiving a multi-layer communication from the network node via the multiple transmissive surfaces.

Some aspects described herein relate to a method of wireless communication performed by a network node. The method may include receiving an indication of a location of a user equipment (UE) within a facility. The method may include transmitting a multi-layer communication to the UE via a transmissive surface on the facility based at least in part on the location of the UE, wherein the transmissive surface is patterned with a phase profile to achieve aperture magnification.

Some aspects described herein relate to a non-transitory computer-readable medium that stores a set of instructions for wireless communication by a first wireless communication device. The set of instructions, when executed by one or more processors of the first wireless communication device, may cause the first wireless communication device to transmit, to a second wireless communication device, coordination information associated with receiving a multi-layer communication from a network node via multiple transmissive surfaces. The set of instructions, when executed by one or more processors of the first wireless communication device, may cause the first wireless communication device to receive the multi-layer communication from the network node via the multiple transmissive surfaces.

Some aspects described herein relate to a non-transitory computer-readable medium that stores a set of instructions for wireless communication by a wireless communication device. The set of instructions, when executed by one or more processors of the wireless communication device, may cause the wireless communication device to transmit, to a network node, information indicating an availability of multiple antenna modules for communicating uncorrelated streams via multiple transmissive surfaces. The set of instructions, when executed by one or more processors of the wireless communication device, may cause the wireless communication device to receive a multi-layer communication from the network node via the multiple transmissive surfaces.

Some aspects described herein relate to a non-transitory computer-readable medium that stores a set of instructions for wireless communication by a wireless communication device. The set of instructions, when executed by one or more processors of the wireless communication device, may cause the wireless communication device to transmit, to a network node, information indicating a rank denoting a quantity of uncorrelated streams that can be communicated via multiple transmissive surfaces. The set of instructions, when executed by one or more processors of the wireless communication device, may cause the wireless communication device to receive a multi-layer communication from the network node via the multiple transmissive surfaces.

Some aspects described herein relate to a non-transitory computer-readable medium that stores a set of instructions for wireless communication by a network node. The set of instructions, when executed by one or more processors of the network node, may cause the network node to receive an indication of a location of a UE within a facility. The set of instructions, when executed by one or more processors of the network node, may cause the network node to transmit a multi-layer communication to the UE via a transmissive surface on the facility based at least in part on the location of the UE, wherein the transmissive surface is patterned with a phase profile to achieve aperture magnification.

Some aspects described herein relate to a first wireless communication device for wireless communication. The first wireless communication device may include one or more memories and one or more processors coupled to the one or more memories. The one or more processors may be configured to transmit, to a second wireless communication device, coordination information associated with receiving a multi-layer communication from a network node via multiple transmissive surfaces. The one or more processors may be configured to receive the multi-layer communication from the network node via the multiple transmissive surfaces.

Some aspects described herein relate to a wireless communication device for wireless communication. The wireless communication device may include one or more memories and one or more processors coupled to the one or more memories. The one or more processors may be configured to transmit, to a network node, information indicating an availability of multiple antenna modules for communicating uncorrelated streams via multiple transmissive surfaces. The one or more processors may be configured to receive a multi-layer communication from the network node via the multiple transmissive surfaces.

Some aspects described herein relate to a wireless communication device for wireless communication. The wireless communication device may include one or more memories and one or more processors coupled to the one or more memories. The one or more processors may be configured to transmit, to a network node, information indicating a rank denoting a quantity of uncorrelated streams that can be communicated via multiple transmissive surfaces. The one or more processors may be configured to receive a multi-layer communication from the network node via the multiple transmissive surfaces.

Some aspects described herein relate to a network node for wireless communication. The network node may include one or more memories and one or more processors coupled to the one or more memories. The one or more processors may be configured to receive an indication of a location of a UE within a facility. The one or more processors may be configured to transmit a multi-layer communication to the UE via a transmissive surface on the facility based at least in part on the location of the UE, wherein the transmissive surface is patterned with a phase profile to achieve aperture magnification.

Some aspects described herein relate to an apparatus for wireless communication. The apparatus may include means for transmitting, to a second wireless communication device, coordination information associated with receiving a multi-layer communication from a network node via multiple transmissive surfaces. The apparatus may include means for receiving the multi-layer communication from the network node via the multiple transmissive surfaces.

Some aspects described herein relate to an apparatus for wireless communication. The apparatus may include means for transmitting, to a network node, information indicating an availability of multiple antenna modules for communicating uncorrelated streams via multiple transmissive surfaces. The apparatus may include means for receiving a multi-layer communication from the network node via the multiple transmissive surfaces.

Some aspects described herein relate to an apparatus for wireless communication. The apparatus may include means for transmitting, to a network node, information indicating a rank denoting a quantity of uncorrelated streams that can be communicated via multiple transmissive surfaces. The apparatus may include means for receiving a multi-layer communication from the network node via the multiple transmissive surfaces.

Some aspects described herein relate to an apparatus for wireless communication. The apparatus may include means for receiving an indication of a location of a UE within a facility. The apparatus may include means for transmitting a multi-layer communication to the UE via a transmissive surface on the facility based at least in part on the location of the UE, wherein the transmissive surface is patterned with a phase profile to achieve aperture magnification.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example of wireless signal refraction, in accordance with the present disclosure.

FIG. 4 is a diagram illustrating an example of communications in the presence of a blocking object, in accordance with the present disclosure.

FIGS. 5A-5D are diagrams of examples associated with communications through blocking objects via transmissive surfaces, in accordance with the present disclosure.

FIG. 6 is a diagram illustrating an example associated with a pattern on a transmissive surface to improve wireless signal pass-through, in accordance with the present disclosure.

FIG. 7 is diagram illustrating an example associated with multi-layer communications, in accordance with the present disclosure.

FIG. 8 is diagram illustrating an example associated with transmissive surface enabled multi-layer communications, in accordance with the present disclosure.

FIG. 9 is a diagram illustrating an example associated with utilizing multiple transmissive surfaces to enable multi-layer communications, in accordance with the present disclosure.

FIG. 10 is a diagram illustrating an example associated with a partially connected hybrid architecture, in accordance with the present disclosure.

FIG. 11 is a diagram illustrating an example associated with utilizing multiple transmissive surfaces to enable multi-layer communications, in accordance with the present disclosure.

FIG. 12 is a diagram illustrating an example associated with utilizing multiple transmissive surfaces to enable multi-layer communications, in accordance with the present disclosure.

FIG. 13 is a diagram illustrating an example associated with utilizing multiple transmissive surfaces to enable multi-layer communications, in accordance with the present disclosure.

FIG. 14 is a diagram illustrating an example associated with utilizing a single transmissive surface to enable multi-layer communications, in accordance with the present disclosure.

FIG. 15 is a diagram illustrating an example process performed at a first wireless communication device or an apparatus of a first wireless communication device, in accordance with the present disclosure.

FIG. 16 is a diagram illustrating an example process performed at a wireless communication device or an apparatus of a wireless communication device, in accordance with the present disclosure.

FIG. 17 is a diagram illustrating an example process performed at a wireless communication device or an apparatus of a wireless communication device, in accordance with the present disclosure.

FIG. 18 is a diagram illustrating an example process performed at a network node or an apparatus of a network node, in accordance with the present disclosure.

FIG. 19 is a diagram of an example apparatus for wireless communication, in accordance with the present disclosure.

FIG. 20 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. For example, an apparatus may be implemented or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A blocking object can be any object that attenuates and/or blocks radio frequency signals incident upon at least one surface (which may be referred to as a “blocking surface”) of the object. In some cases, for example, a blocking object may be a building, a wall of a building, a window of a building, a vehicle, a side of a vehicle, and/or a window of a vehicle, among other examples. In some cases, for example, a region on a first side of a blocking object may be an indoor environment, and a region on a second side of the blocking object may be an outdoor environment.

In some cases, the blocking object may be a side of a building. In some cases, one or more UEs can be at respective locations (e.g., within the building) within a first region. In some cases, the first region is an indoor environment. A network node can be at a location in a second region (e.g., an outdoor environment) such that the blocking object is disposed between the network node and the one or more UEs (e.g., due to the blocking object being disposed between the location and the respective locations of the one or more UEs). Thus, signals communicated between the network node and the one or more UEs can be attenuated and/or blocked by the blocking object. In some cases, for example, the network node can transmit beamformed synchronization signals such as, for example, synchronization signal blocks (SSBs). The SSBs may be attenuated and/or blocked by the blocking object. In this way, penetration loss (especially related to, but not restricted to, high-frequency signals) can severely restrict the cellular coverage within an indoor environment.

In some cases, for example, a blocking object, such as a side of a building, may include a number of different blocking surfaces, each of which may cause a respective type and/or amount of signal attenuation. For example, in some cases, construction materials such as concrete and tinted glass can allow an incident beam to pass through but can significantly weaken the respective strengths (e.g., power) of the signals. As a result, a UE in an indoor environment can often only experience poor cellular signal quality, which further deteriorates as the UE moves deeper indoors, away from the external façade of the building. Similarly, penetration loss due to glass surfaces (e.g., vehicle windows) may reduce the signal quality inside of vehicles (e.g., automobiles, trains, and/or aircraft, among other examples). Additionally, since only some of the SSBs transmitted by a network node may be relevant for indoor users within a building or vehicle, a UE can waste power resources searching for beams that are not relevant.

Reconfigurable intelligent surfaces (RISs) have emerged as potential solutions to expand a cellular footprint by removing coverage blind-spots. An RIS may include an array of reflecting elements that can be dynamically reconfigured to control the reflection and scattering of electromagnetic waves. Recently, RISs have also been proposed as an array of transmissive or refracting elements that can be dynamically reconfigured to redirect and pass through incident radiation. Using an RIS as a reconfigurable transmissive/refractive surface can improve outside-to-inside (“out-to-in”) coverage in some cases. However, RISs include transmissive surfaces that are not passive (e.g., since RISs include active RF elements that support reconfigurability) and, therefore, can include a non-negligible cost in terms of signal attenuation and/or power consumption, as well as signal power loss (e.g., insertion loss). In some cases, a portion of a glass façade can be treated with a transmissive coating (and/or replaced with a low-loss surface) to passively reduce penetration loss. However, using a low-loss surface or a coated surface as a transmissive surface by itself does not redirect beams and, as a result, the size of such a surface in combination with an angle of incidence of a beam can still result in limited regions of improved coverage.

Various aspects relate generally to transmissive surfaces (TSs) for improving signal transmission through blocking objects. Some aspects more specifically relate to a TS that enables multi-layer communications through blocking objects. In some aspects, a TS may be patterned to achieve a target transmission field of view (FoV). As used herein, “field of view” or “FoV” may refer to a two-dimensional and/or a three-dimensional region corresponding to cellular coverage (e.g., provided by one or more beams). In some cases, the target transmission FoV may cover a wireless communication device. As used herein, an FoV may be described as “covering” a device when wireless signals within the FoV are stronger at the device than if the device were outside of the FoV.

In some aspects, a network node and multiple wireless communication devices may communicate through a blocking object via multiple TSs. In some aspects, a distance between the multiple TSs may enable multi-layer spatial division multiplexed communication between the network node and the wireless communication devices. In some aspects, the distance between the multiple TSs may be based at least in part on a distance between the network node and the multiple TSs. In some aspects, the distance between the multiple TSs may be based at least in part on a quantity of elements in an antenna array of the network node. In some aspects, the multiple TSs may enable multiple wireless communication devices to be served using a same radio frequency (RF) beam. In some aspects, multiple network nodes may communicate with a single wireless communication device via a TS. In some aspects, a single network node and a single wireless communication device may communicate via one or more TSs.

Particular aspects of the subject matter described in this disclosure can be implemented to realize one or more of the following potential advantages. In some examples, the described techniques can be used to enable multi-layer communications between a network node and a wireless communication device through a blocking object using one or more passive transmissive surfaces (e.g., rather than active transmissive surfaces requiring tunable components and a power supply). In some examples, by enabling multi-layer communications, an amount of data communicated between the network node and the wireless communication device can be increased relative to using single-layer communications.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (for example, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. For example, 5G New Radio (NR) is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (for example, cellular vehicle-to-everything (CV2X) communication), frequency spectrum expansion, overlapping spectrum use, small cell deployments, non-terrestrial network (NTN) deployments, device aggregation, advanced duplex communication (for example, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

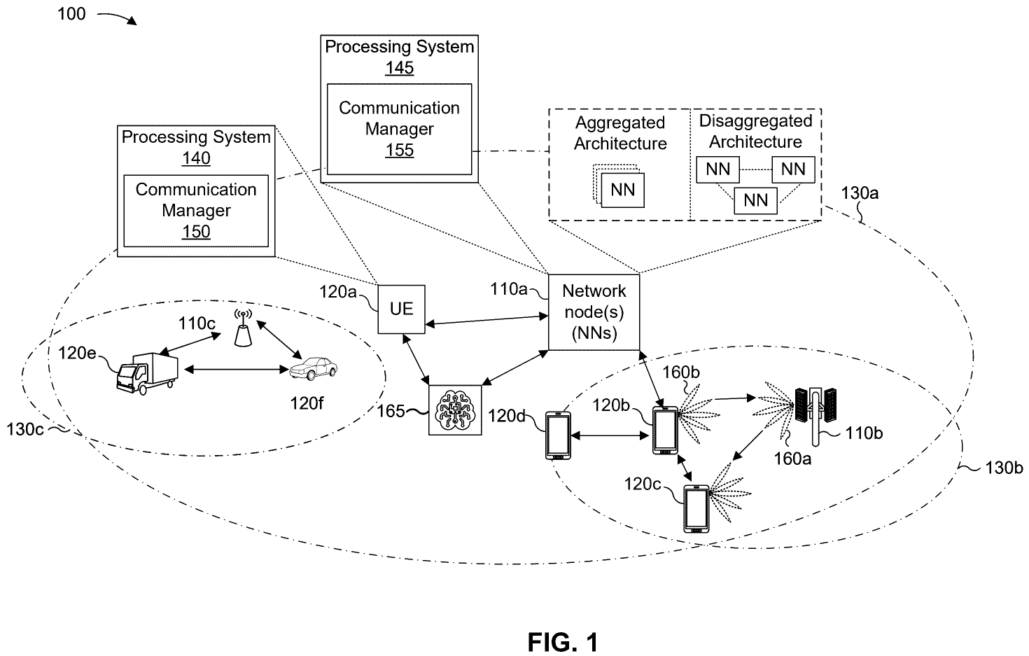

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. For example, in FIG. 1, the wireless communication network 100 includes a network node (NN) 110a, a network node 110b, and a network node 110c. The network nodes 110 may support communications with multiple UEs 120. For example, in FIG. 1, the network nodes 110 support communication with a UE 120a, a UE 120b, a UE 120c, a UE 120d, a UE 120e, and a UE 120f. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. For example, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (for example, based on user demand) in a single frequency band. In some examples, the wireless communication network 100 may support communication over unlicensed spectrum, where access to an unlicensed channel is subject to a channel access mechanism. For example, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHz), FR2 (24.25 GHz through 52.6 GHz), FR3 (7.125 GHz through 24.25 GHz), FR4a or FR4-1 (52.6 GHz through 71 GHz), FR4 (52.6 GHz through 114.25 GHz), and FR5 (114.25 GHz through 300 GHz). Although a portion of FR1 is greater than 6 GHz, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHz,” if used herein, may broadly refer to frequencies that are less than 6 GHz, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. For example, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (for example, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (for example, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (for example, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (for example, a single physical structure) or may be implemented as two or more physical nodes (for example, two or more distinct physical structures). For example, a network node 110 may be a device or system that implements a part of a radio protocol stack, a device or system that implements a full radio protocol stack (such as a full gNB protocol stack), or a collection of devices or systems that collectively implement the full radio protocol stack. For example, and as shown, a network node 110 may be an aggregated network node having an aggregated architecture, meaning that the network node 110 may implement a full radio protocol stack that is physically and logically integrated within a single physical structure in the wireless communication network 100. For example, an aggregated network node 110 may consist of a single standalone base station or a single TRP that operates with a full radio protocol stack to enable or facilitate communication between a UE 120 and a core network of the wireless communication network 100.

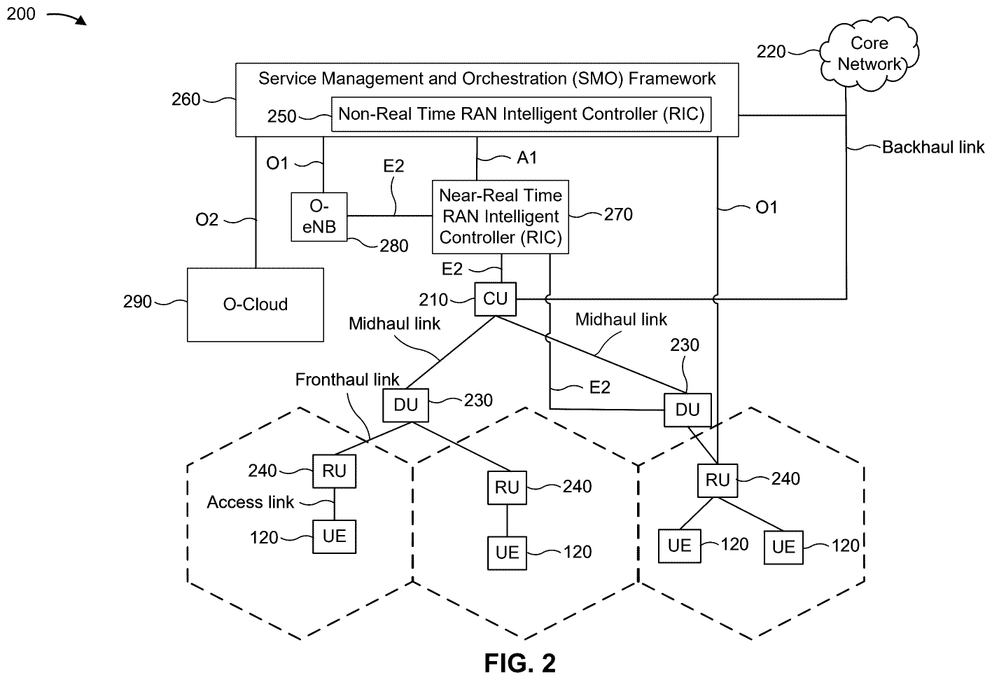

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (for example, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (for example, each cell may support communication within an angular (for example, 60 degree) range around the network node). In some examples, a network node 110 may provide communication coverage for a macro cell, a pico cell, a femto cell, or another type of cell. A macro cell may cover a relatively large geographic area (for example, several kilometers in radius) and may allow unrestricted access by UEs 120 with associated service subscriptions. A pico cell may cover a relatively small geographic area and may also allow unrestricted access by UEs 120 with associated service subscriptions. A femto cell may cover a relatively small geographic area (for example, a home) and may allow restricted access by UEs 120 having association with the femto cell (for example, UEs 120 in a closed subscriber group (CSG)). In some examples, a cell may not necessarily be stationary. For example, the geographic area of the cell may move according to the location of an associated mobile network node 110 (for example, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (for example, a cell 130a, a cell 130b, and a cell 130c), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (for example, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (for example, a smart watch, smart clothing, smart glasses, a smart wristband, smart jewelry, a gaming device, an entertainment device (for example, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (for example, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, for example, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (for example, frames, subframes, slots, and symbols), frequency domain resources (for example, frequency bands, component carriers (CCs), subcarriers, resource blocks, and resource elements), and spatial domain resources (for example, particular transmit directions or beams).

Frequency domain resources may be subdivided into bandwidth parts (BWPs). A BWP may be a block of frequency domain resources (for example, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (for example, by a network node 110 transmitting a downlink control information (DCI) configuration to the one or more UEs 120) and/or reconfigured (for example, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (for example, RedCap) UEs 120 by facilitating the configuration of smaller bandwidths for communication by such UEs 120 and/or by facilitating reduced UE power consumption.

As used herein, a downlink signal may be or include a reference signal, control information, or data. For example, downlink reference signals include a primary synchronization signal (PSS), a secondary SS (SSS), an SS block (SSB) (for example, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot formal indicators (SFIs), preemption indicators (PIs), transmit power control (TPC) commands, hybrid automatic repeat request (HARQ) information, new data indicators (NDIs), among other examples. A downlink data channel may be used to transmit downlink data (for example, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. For example, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. For example, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (for example, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. For example, a PUCCH can carry UCI, while a PUSCH can carry a MAC-CE, an RRC message, or user data, among other examples. UCI can include a scheduling request (SR), HARQ feedback information (for example, a HARQ acknowledgement (ACK) indication or a HARQ negative acknowledgement (NACK) indication), uplink power control information (for example, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (for example, indicative of a beam used to transmit a CSI-RS), an SS/PBCH resource block indicator (SSBRI) (for example, indicative of a beam used to transmit an SSB), a layer indicator (LI), a rank indicator (RI), and/or measurement information (for example, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (for example, data, control information, or reference signal information) transmitted by a network node 110 to a UE 120, or vice versa, may be represented as a sequence of binary bits that are mapped (for example, modulated) to an analog signal waveform (for example, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (for example, using the processing system 145 or the processing system 140, respectively) may select an MCS (for example, an order of quadrature amplitude modulation (QAM), such as 64-QAM, 128-QAM, or 256-QAM, among other examples) for a downlink signal or an uplink signal. For example, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (for example, using the processing system 145 or the processing system 140, respectively, and/or one or more coupled encoders or modems) may perform a channel coding operation or a forward error correction (FEC) operation to control errors in transmitted information. For example, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (for example, using the processing system 145 and/or one or more modems) may further perform spatial processing (for example, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (for example, a precoding matrix) using a codebook. For example, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (for example, using the processing system 145 or the processing system 140, respectively, and/or one or more coupled modems) may perform signal processing (for example, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (for example, received information) that estimates the information transmitted by the network node 110 or the UE 120 via the downlink or uplink signals. The network node 110 or the UE 120 (for example, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. For example, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. For example, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (for example, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (for example, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. For example, an initial beam acquisition operation may involve the network node 110 transmitting signals (for example, SSBs, CSI-RSs, or other signals) via respective beams (for example, of the beams 160a of the network node 110) and the UE 120 receiving and measuring the signal(s) via respective beams of multiple beams (for example, from the beams 160b of the UE 120) to identify a best beam (or beam pair) for communication between the UE 120 and the network node 110. For example, the UE 120 may transmit an indication (for example, in a message associated with a random access channel (RACH) operation) of a (best) identified beam of the network node 110 (for example, by indicating an SSBRI or other identifier associated with the beam). A beam refinement operation may involve a first device (for example, the UE 120 or the network node 110) transmitting signal(s) via a subset of beams (for example, identified based on, or otherwise associated with, measurements reported as part of one or more other beam management operations). A second device (for example, the network node 110 or the UE 120) may receive the signal(s) via a single beam (for example, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (for example, referred to herein as an “AI/ML model”), such as a program that includes a machine learning (ML) model and/or an artificial neural network (ANN) model. The AI/ML model may be deployed at one or more devices 165 (for example, a network node 110 and/or UEs 120). For example, the one or more devices 165 may include a UE 120 (for example, the processing system 140), a network node 110 (for example, the processing system 145), one or more servers, and/or one or more components of a cloud computing network, among other examples. In some examples, the AI/ML model (or an instance of the AI/ML model) may be deployed at multiple devices (for example, a first portion of the AI/ML model may be deployed at a UE 120 and a second portion of the AI/ML model may be deployed at a network node 110). In other examples, a first AI/ML model may be deployed at a UE 120 and a second AI/ML model may be deployed at a network node 110. The AI/ML model(s) may be configured to enhance various aspects of the wireless communication network 100. For example, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

In some examples, two or more UEs 120 (for example, shown as UE 120b and UE 120d or the UE 120e and the UE 120f) may communicate directly with one another using sidelink communications (for example, without communicating by way of a network node 110 as an intermediary). As an example, the UE 120b may directly transmit data, control information, or other signaling as a sidelink communication to the UE 120d. This is in contrast to, for example, the UE 120b first transmitting data in an uplink communication to a network node 110, which then transmits the data to the UE 120d in a downlink communication. In various examples, the UEs 120 may transmit and receive sidelink communications using peer-to-peer (P2P) communication protocols, device-to-device (D2D) communication protocols, vehicle-to-everything (V2X) communication protocols (which may include vehicle-to-vehicle (V2V) protocols, vehicle-to-infrastructure (V2I) protocols, and/or vehicle-to-pedestrian (V2P) protocols), and/or mesh network communication protocols. In some deployments and configurations, a network node 110 may schedule and/or allocate resources for sidelink communications between UEs 120 in the wireless communication network 100. For example, the cell 130c may include a V2X network supported by the network node 110c. In some examples, the network node 110c may be a roadside unit or other device deployed in the V2X network. In some other deployments and configurations, a UE 120 (instead of a network node 110) may perform, or collaborate or negotiate with one or more other UEs to perform, scheduling operations, resource selection operations, and/or other operations for sidelink communications. Sidelink data and control transmissions (that is, transmissions directly between two or more UEs 120) may generally use similar techniques as were described for uplink data and control transmission, and may use sidelink-specific channels such as a physical sidelink shared channel (PSSCH), a physical sidelink control channel (PSCCH), and/or a physical sidelink feedback channel (PSFCH).

In some aspects, a first wireless communication device (e.g., a UE 120) may include a communication manager 150. As described in more detail elsewhere herein, the communication manager 150 may transmit, to a second wireless communication device, coordination information associated with receiving a multi-layer communication from a network node via multiple transmissive surfaces; and receive the multi-layer communication from the network node via the multiple transmissive surfaces.

In some aspects, the communication manager 150 may transmit, to a network node, information indicating an availability of multiple antenna modules for communicating uncorrelated streams via multiple transmissive surfaces; and receive a multi-layer communication from the network node via the multiple transmissive surfaces.

In some aspects, the communication manager 150 may transmit, to a network node, information indicating a rank denoting a quantity of uncorrelated streams that can be communicated via multiple transmissive surfaces; and receive a multi-layer communication from the network node via the multiple transmissive surfaces. Additionally, or alternatively, the communication manager 150 may perform one or more other operations described herein.

In some aspects, the network node 110 may include a communication manager 155. As described in more detail elsewhere herein, the communication manager 155 may receive an indication of a location of a UE within a facility; and transmit a multi-layer communication to the UE via a transmissive surface on the facility based at least in part on the location of the UE, wherein the transmissive surface is patterned with a phase profile to achieve aperture magnification. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (for example, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. For example, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an AI interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. For example, the Non-RT RIC 250 may monitor long-term trends and patterns for performance and may employ AI/ML models to perform corrective actions via the SMO Framework 260 (such as reconfiguration via an O1 interface) or via creation of RAN management policies (such as AI interface policies).

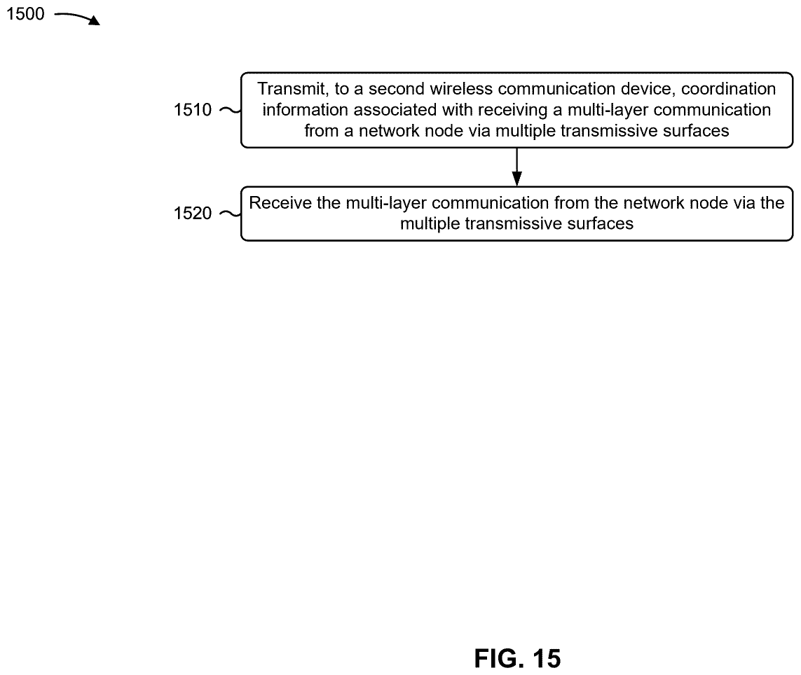

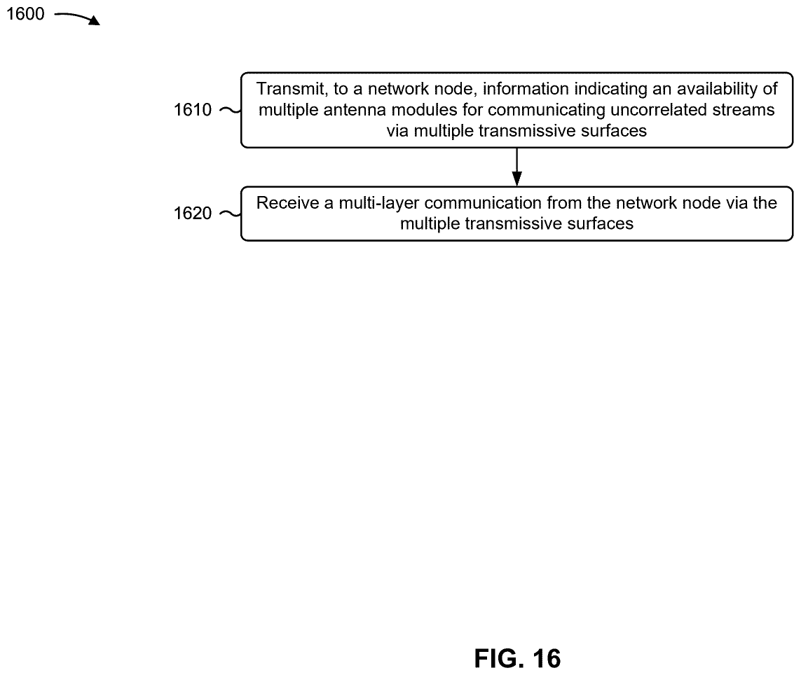

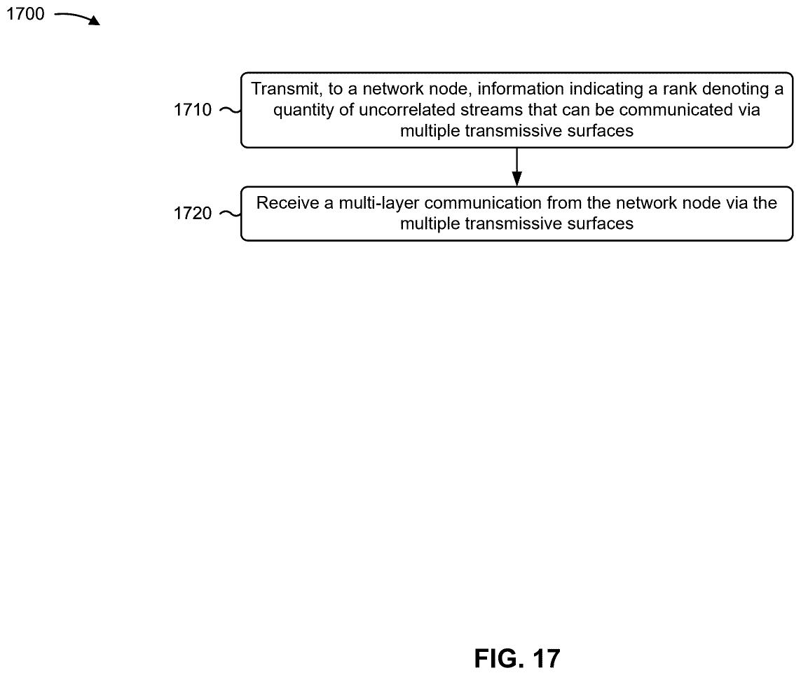

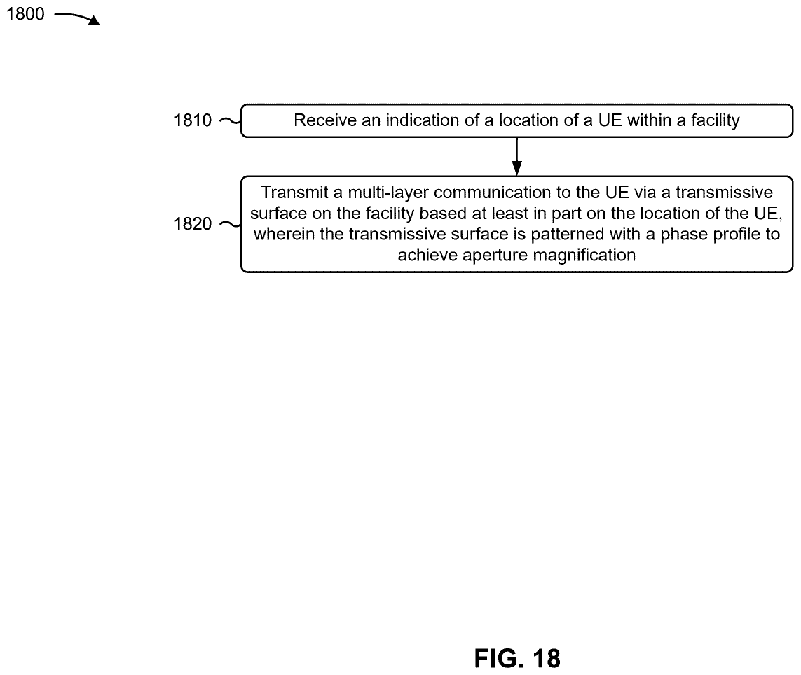

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with transmissive surface enabled multi-layer communications, as described in more detail elsewhere herein. For example, the processing system 145 of the network node 110, the processing system 140 of the UE 120, the CU 210, the DU 230, or the RU 240 may perform or direct operations of, for example, process 1500 of FIG. 15, process 1600 of FIG. 16, process 1700 of FIG. 17, process 1800 of FIG. 18, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. For example, the set of instructions, when executed by one or more processors (for example, of the processing system 145 or the processing system 140) of the network node 110, the UE 120, the CU 210, the DU 230, or the RU 240, may cause the one or more processors to perform process 1500 of FIG. 15, process 1600 of FIG. 16, process 1700 of FIG. 17, process 1800 of FIG. 18, or other processes as described herein. In some examples, executing instructions may include running the instructions, converting the instructions, compiling the instructions, and/or interpreting the instructions, among other examples.

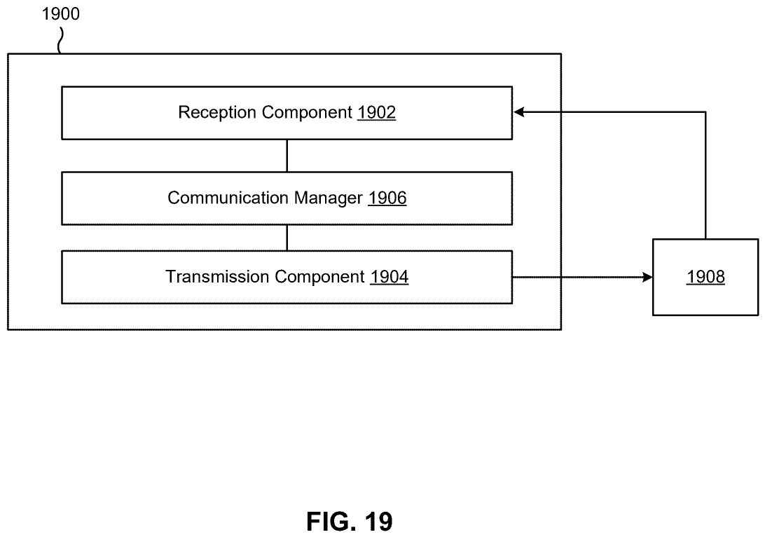

In some aspects, a first wireless communication device includes means for transmitting, to a second wireless communication device, coordination information associated with receiving a multi-layer communication from a network node via multiple transmissive surfaces; and/or means for receiving the multi-layer communication from the network node via the multiple transmissive surfaces. In some aspects, the means for the first wireless communication device to perform operations described herein may include, for example, one or more of communication manager 150, processing system 140, a radio, one or more RF chains, one or more transceivers, one or more antennas, one or more modems, a reception component (for example, reception component 1902 depicted and described in connection with FIG. 19), and/or a transmission component (for example, transmission component 1904 depicted and described in connection with FIG. 19), among other examples.

In some aspects, a wireless communication device includes means for transmitting, to a network node, information indicating an availability of multiple antenna modules for communicating uncorrelated streams via multiple transmissive surfaces; and/or means for receiving a multi-layer communication from the network node via the multiple transmissive surfaces. In some aspects, the means for the wireless communication device to perform operations described herein may include, for example, one or more of communication manager 150, processing system 140, a radio, one or more RF chains, one or more transceivers, one or more antennas, one or more modems, a reception component (for example, reception component 1902 depicted and described in connection with FIG. 19), and/or a transmission component (for example, transmission component 1904 depicted and described in connection with FIG. 19), among other examples.

In some aspects, a wireless communication device includes means for transmitting, to a network node, information indicating a rank denoting a quantity of uncorrelated streams that can be communicated via multiple transmissive surfaces; and/or means for receiving a multi-layer communication from the network node via the multiple transmissive surfaces. In some aspects, the means for the wireless communication device to perform operations described herein may include, for example, one or more of communication manager 150, processing system 140, a radio, one or more RF chains, one or more transceivers, one or more antennas, one or more modems, a reception component (for example, reception component 1902 depicted and described in connection with FIG. 19), and/or a transmission component (for example, transmission component 1904 depicted and described in connection with FIG. 19), among other examples.

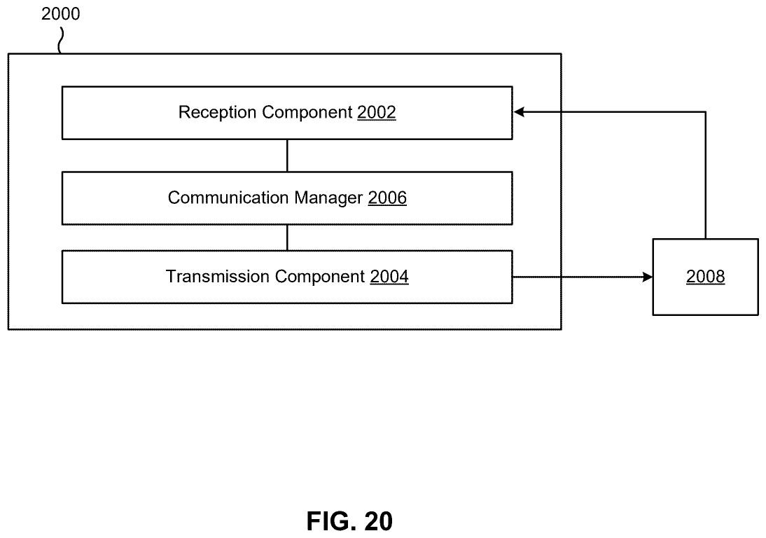

In some aspects, a network node includes means for receiving an indication of a location of a UE within a facility; and/or means for transmitting a multi-layer communication to the UE via a transmissive surface on the facility based at least in part on the location of the UE, wherein the transmissive surface is patterned with a phase profile to achieve aperture magnification. The means for the network node to perform operations described herein may include, for example, one or more of communication manager 155, processing system 145, a radio, one or more RF chains, one or more transceivers, one or more antennas, one or more modems, a reception component (for example, reception component 2002 depicted and described in connection with FIG. 20), and/or a transmission component (for example, transmission component 2004 depicted and described in connection with FIG. 20), among other examples.

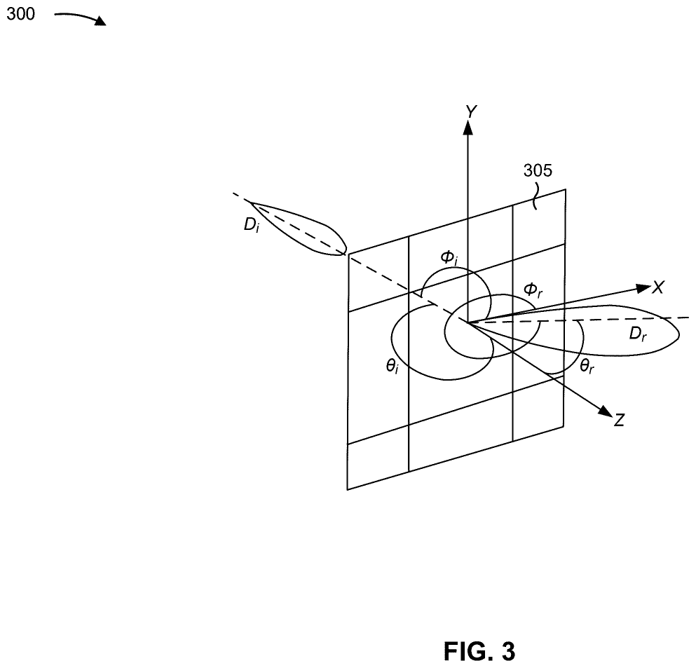

FIG. 3 is a diagram illustrating an example 300 of wireless signal refraction, in accordance with the present disclosure. As shown in FIG. 3, an incoming signal (along vector Dᵢ) is characterized by an azimuthal angle Φᵢ and an elevation angle θᵢ with respect to the axes X, Y, and Z of a transmissive surface 305. The incoming signal is refracted by the transmissive surface 305, which results in a refracted signal along vector Dᵣ. The refracted signal is characterized by an azimuthal angle Φᵣ and an elevation angle θᵣ with respect to the axes X, Y, and Z. The azimuthal angles Φᵢ and Φᵣ are determined using projections of vectors Dᵢ and Dᵣ, respectively, on the X-Y plane; these projections are not shown in FIG. 3. A refraction coefficient η of the transmissive surface 355 may thus be optimized by maximizing the following metric:

$${η}_{max - min} = {min}_{1 \leq n \leq L} \{ \vert f ( {θ}_{n} , {ϕ}_{n} ) \vert \} ,$$

where f represents gain as a function of azimuthal and elevation angle and L represents a sampling directions in a target transmission FoV. Computationally, optimization of the refraction coefficient η may be performed using a Genie metric based algorithm that minimizes the Genie metric, as shown below:

$${η}_{genie} = \frac{\sum \vert \vert f ( {θ}_{n} , {ϕ}_{n} ) \vert - \vert f ( {θ}_{m} , {ϕ}_{m} ) \vert \vert}{2 L ( {\sum }_{n = 1}^{L} \vert f ( {θ}_{n} , {ϕ}_{n} ) \vert )} .$$

Another example of computationally optimization of the refraction coefficient η could be performed by maximizing the diffusion metric, as shown below:

$${η}_{diffusion} = \frac{{( {\sum }_{n = 1}^{L} \vert f ( {θ}_{n} , {ϕ}_{n} ) \vert )}^{2} - {\sum }_{n = 1}^{L} {\vert f ( {θ}_{n} , {ϕ}_{n} ) \vert}^{2}}{( L - 1 ) ( {\sum }_{n = 1}^{L} {\vert f ( {θ}_{n} , {ϕ}_{n} ) \vert}^{2} )} .$$

As indicated above, FIG. 3 is provided as example. Other examples may differ from what is described with respect to FIG. 3.

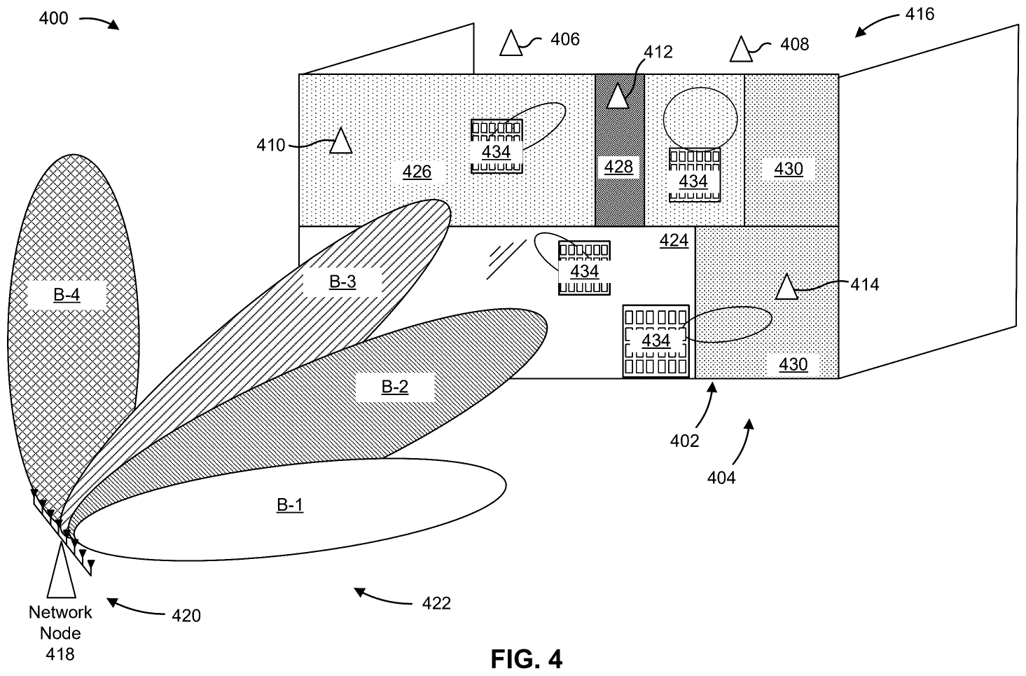

FIG. 4 is a diagram illustrating an example 400 of communications in the presence of a blocking object 402, in accordance with the present disclosure, A blocking object can be any object that attenuates and/or blocks radio frequency signals incident upon at least one surface (which may be referred to as a “blocking surface”) of the object. In some cases, for example, a blocking object may be a building, a wall of a building, a window of a building, a vehicle, a side of a vehicle, and/or a window of a vehicle, among other examples. In some cases, for example, a region on a first side of a blocking object may be an indoor environment, and a region on a second side of the blocking object may be an outdoor environment.

In example 400, the blocking object 402 is a side of a building 404. In some cases, as shown, one or more UEs 406, 408, 410, 412, and 414 can be at respective locations (e.g., within the building 404) within a first region 416. In example 400, the first region 416 is an indoor environment. A network node 418 can be at a location 420 in a second region 422 (e.g., an outdoor environment) such that the blocking object 402 is disposed between the network node 418 and the one or more UEs 406, 408, 410, 412, and 414 (e.g., due to the blocking object being disposed between the location 420 and the respective locations of the one or more UEs 406, 408, 410, 412, and 414). Thus, signals communicated between the network node 418 and the one or more UEs 406, 408, 410, 412, and 414 can be attenuated and/or blocked by the blocking object 402. In some cases, for example, the network node 418 can transport beamformed synchronization signals such as, for example, SSBs. The SSBs may be attenuated and/or blocked by the blocking object. In this way, penetration loss (especially related to, but not restricted to, high-frequency signals) can severely restrict the cellular coverage within an indoor environment.

In some cases, for example, a blocking object such as a side of a building (e.g., the blocking object 402) may include a number of different blocking surfaces, each of which may cause a respective type and/or amount of signal attenuation. For example, as shown, the blocking object 402 may include a first blocking surface 424 (e.g., a first glass façade), a second blocking surface 426 (e.g., a second glass façade), a third blocking surface 428 (e.g., concrete), and a fourth blocking surface 430 (e.g., a brick wall). Each of the blocking surfaces 424, 426, 428, and 430 may cause a different, respective degree of attenuation to RF signals being transmitted between the network node 418 and the one or more UEs 406, 408, 410, 412, and 414. For example, in some cases, construction materials such as concrete and tinted glass can pass allow an incident beam to pass through but can significantly weaken the respective strengths (e.g., power) of the signals. As a result, a UE in an indoor environment can often only experience poor cellular signal quality, which further deteriorates as the UE moves deeper indoors, away from the external façade of the building. Similarly, penetration loss due to glass surfaces (e.g., vehicle windows) may reduce the signal quality inside of vehicles (e.g., automobiles, trains, and/or aircraft, among other examples).

In some cases, RISs have emerged as potential solutions to expand footprint by removing coverage blind-spots. An RIS may include an array of reflecting elements that can be dynamically reconfigured to control the reflection and scattering of electromagnetic waves. Recently, RISs have also been proposed as an array of transmissive or refracting elements that can be dynamically reconfigured to redirect and pass through incident radiation. Using an RIS as a reconfigurable transmissive/refractive surface can improve outside-to-inside (“out-to-in”) coverage in some cases. However, RISs include transmissive surfaces that are not passive (e.g., since RISs include active RF elements that support reconfigurability) and, therefore, can include a non-negligible cost in terms of signal attenuation and/or power consumption, as well as signal power loss (e.g., insertion loss). In some cases, a portion of a glass façade can be treated with a transmissive coating (and/or replaced with a low-loss surface) to passively reduce penetration loss. However, using a low-loss surface or a coated surface as a transmissive surface by itself does not redirect beams and, as a result, the size of such a surface in combination with an angle of incidence of a beam can still result in limited regions of improved coverage.

Some aspects of the techniques described herein may facilitate improved cellular coverage through blocking objects by including at least one TS configured to refract incident signals in association with at least one FOV. An FOV is two-dimensional and/or three-dimensional region corresponding to cellular coverage provided by a beam. In some aspects, an FOV may include a beam footprint. A TS may include a refracting transmissive surface (RTS) and/or an enhanced transmissive surface (ETS), both of which may be configured to refract incident signals. As used herein, “transmissive surface” and “TS” may be used interchangeably with “refracting transmissive surface,” “refracting TS,” and “RTS.”

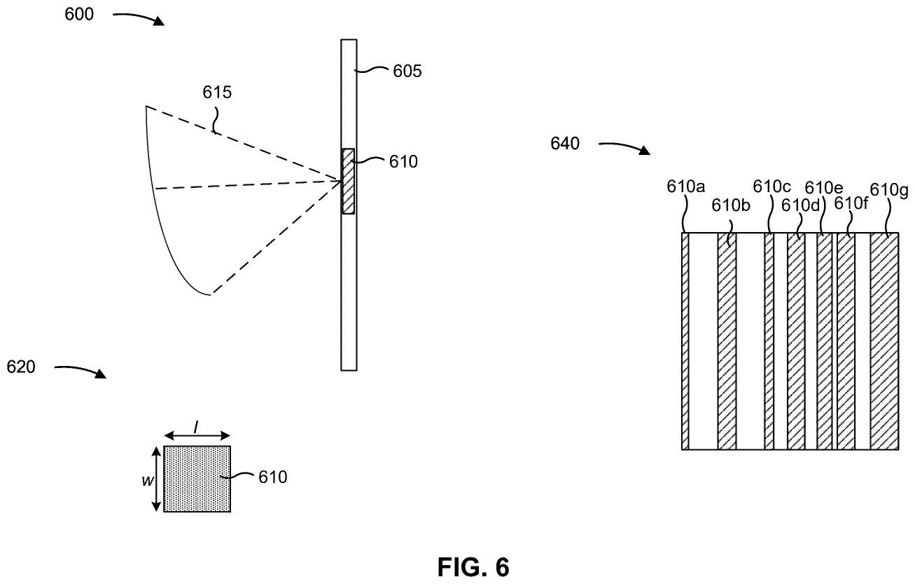

An RTS and/or an ETS may be configured to redirect incident beams and/or widen incident beams. An ETS may be configured to split incident beams into multiple beams (having the same or different attributes). For example, as shown, a number of TSs 434 may be disposed on the blocking surfaces 426, 428, and 430 to facilitate refracting incident beams such as the beams illustrated (shown as “B-1,” “B-2,” “B-3,” and “B-4”). For example, in some aspects, TSs may be installed and/or coated onto one or more façade glass-surfaces. TSs may be fully passive and may anomalously refract incident signals along configured narrow or broad beams based on the patterns imprinted on them as described in more detail with respect to FIG. 6. In some aspects, the TSs may include ETSs. Each ETS may be configured to have different refracted beams for different frequencies and/or have multi-finger refracted beams at an operating frequency. In some aspects, an effective path-loss of a cellular signal seen by an indoor user in coverage of a refracted beam can be significantly reduced by employing the TSs. Together, multiple TSs may be used to provide customized indoor coverage for a building interior and/or a vehicle interior.

In some cases, a UE in an indoor location inside a facility housing TSs may assist in discovering the presence of such TSs. For example, the UE may sense and/or measure significantly improved signal quality compared to nearby locations. In some cases, a single SSB peak may be detected with substantially improved signal strength at a location, which is an outlier compared to nearby locations. For example, the UE may detect a presence of a TS based on a difference between a first SSB peak and a second SSB peak satisfying a threshold.

In some cases, measurements obtained by a UE may be conveyed to a network node and can thus be used, by the network node, to infer the presence of a TS. The UE may also optionally provide further UE assistance information such as data from the UE's sensors (e.g., data associated with orientation and/or altitude, among other examples), and/or a location-indexed historical log of data-rates and/or signal-strengths for a set of locations (e.g., grid points).

As indicated above, FIG. 4 is provided as an example. Other examples may differ from what is described with respect to FIG. 4.

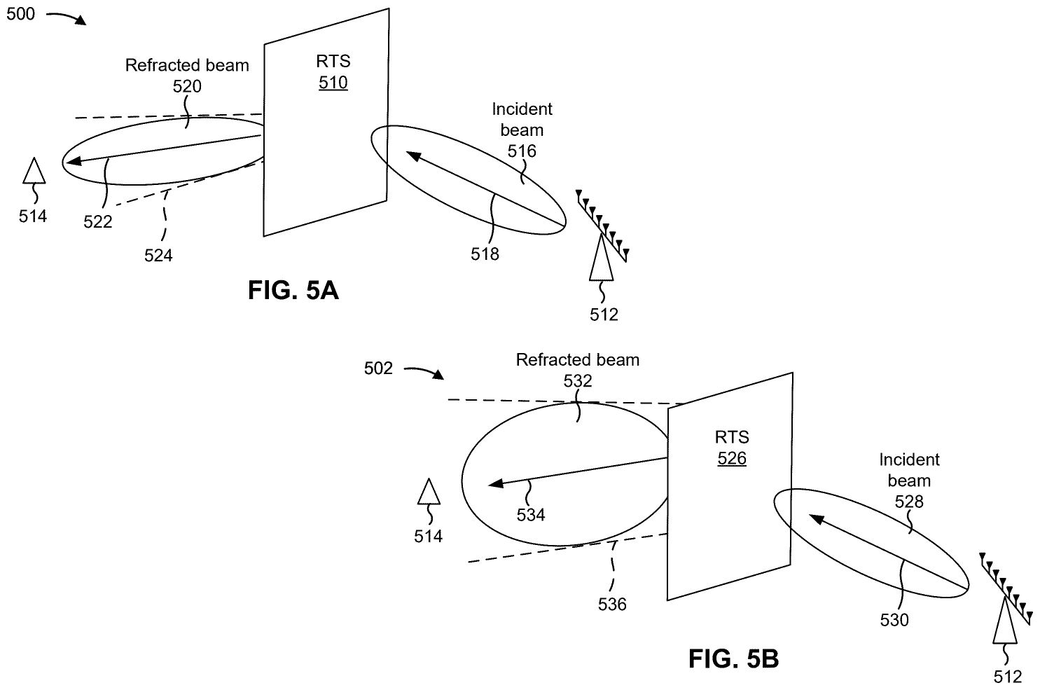

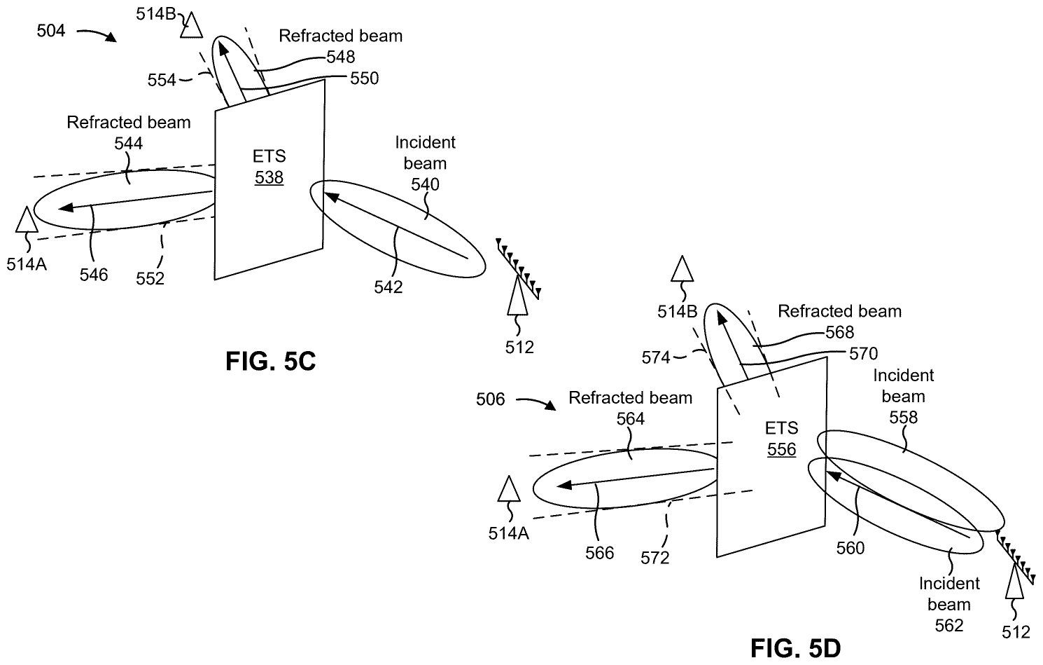

FIGS. 5A-5D are diagrams of examples 500, 502, 504, and 506, respectively, associated with communications through blocking objects via TSs, in accordance with the present disclosure.

As shown in example 500 of FIG. 5A, an RTS 510 may be disposed on a blocking object (not shown) between a network node 512 and a UE 514. The RTS 510 may refract an incident beam 516 having a first transmission direction 518 to generate a refracted beam 520 having a second transmission direction 522. The RTS 510 may include a pattern etched into its surface configured to cause an anomalous refraction along a narrow FOV 524 (e.g., an FOV that is narrower than a beam width of the incident beam 516).

As shown in example 502 of FIG. 5B, an RTS 526 may be disposed on a blocking object (not shown) between the network node 512 and the UE 514. The RTS 526 may refract an incident beam 528 having a first transmission direction 530 to generate a refracted beam 532 having a second transmission direction 534. The RTS 526 may include a pattern etched into its surface configured to cause an anomalous refraction along a broad FOV 536 (e.g., an FOV that is broader than a beam width of the incident beam 528).

As shown in example 504 of FIG. 5C, an ETS 538 may be disposed on a blocking object (not shown) between the network node 512 and UEs 514A and 514B. The ETS 538 may refract an incident beam 540 having a first transmission direction 542 to generate a first refracted beam 544 having a second transmission direction 546 and a second refracted beam 548 having a third transmission direction 550. The ETS 538 may include a pattern etched into its surface configured to cause an anomalous refraction along multiple disparate narrow FOVs 552 and 554, respectively. In some aspects, the ETS 538 may be configured to generate any number of refracted beams based on the incident beam 540.

As shown in example 506 of FIG. 5D, an ETS 556 may be disposed on a blocking object (not shown) between the network node 512 and UEs 514A and 514B. The ETS 556 may refract a first incident beam 558 having a first transmission direction 560 and a first frequency and a second incident beam 562 having the first transmission direction 560 (or a similar transmission direction) and a second frequency to generate a first refracted beam 564 having a second transmission direction 566 and the second frequency and a second refracted beam 568 having a third transmission direction 570 and the first frequency. The ETS 556 may include a pattern etched into its surface configured to cause an anomalous refraction along multiple disparate narrow FOVs 572 and 574, respectively. In some aspects, the ETS 556 may be configured to generate any number of refracted beams based on the incident beams 558 and 562.

As indicated above, FIGS. 5A-5D are provided as examples. Other examples may differ from what is described with respect to FIGS. 5A-5D.

FIG. 6 is a diagram illustrating an example 600 associated with a pattern on a surface to improve wireless signal pass-through, in accordance with the present disclosure. As shown in FIG. 6, the example 600 includes a surface 605 that is at least partially transparent to light. In some aspects, the surface 605 may be (a portion of) a window on a building or a vehicle. In one example, the surface 605 may include soda-lime glass.

The surface 605 may further include a coating configured to reduce emissivity of the surface for infrared and/or UV radiation. In some aspects, the surface 605 may be (a portion of) a low-e window. In one example, the coating may include tin dioxide and/or silver.

As further shown in FIG. 6, the surface 605 may include a pattern 610 on the surface formed by a treatment configured to reduce signal loss of one or more radio frequencies. In some aspects, the one or more radio frequencies include at least one millimeter wave frequency. In one example, the treatment includes an etching process that removes or shapes a portion of the coating according to the pattern 610.

In FIG. 6, the pattern 610 is configured to result in a target transmission FoV 615 for the one or more radio frequencies. For example, the pattern 610 may be optimized to refract incoming signals toward the target transmission FoV, as described in connection with FIG. 3. In some aspects, the pattern 610 may be optimized for a plurality of incident directions (e.g., a set of incident vectors Dᵢ, as described in connection with FIG. 3) for the one or more radio frequencies. Additionally, or alternatively, the pattern 610 may be optimized for a set of target distances from the surface 605 (e.g., where L represents a sampling of distances, as well as directions, as described in connection with FIG. 3, in the target transmission FoV 615).

In some aspects, the pattern 610 may be based at least in part on a maximum infrared emission limit, a maximum UV emission limit, or a minimum visibility limit associated with the surface. For example, dimensions of the pattern 610 (e.g., a length l and/or a width w, as described below) may be selected such that the surface 605 satisfies the maximum infrared emission limit, the maximum UV emission limit, and/or the minimum visibility limit.

In one example, the pattern 610 may be determined using an optimization of worst-case pass-through signal gain for the one or more radio frequencies within the target transmission FoV 615. Additionally, or alternatively, the pattern 610 may be determined using an optimization of a diffusion coefficient or a Gini coefficient computed for a pass-through signal for the one or more radio frequencies within the target transmission FoV 615.

If the surface 605 includes a tinting layer, the pattern 610 may further be determined based at least in part on the tinting layer. For example, any simulations and/or optimizations performed may account for the tinting layer increasing loss of the one or more radio frequencies when signals pass through the pattern 610.

FIG. 6 further illustrates an example 620 of the pattern 610. For example, the pattern 610 may be associated with a length (e.g., represented by l) that is a portion of a total length of the surface 605. Additionally, the pattern 610 may be associated with a width (e.g., represented by w) that is a portion of a total width of the surface 605.

FIG. 6 further illustrates an example 640 of a binary stripe pattern. As shown in FIG. 6, the binary stripe pattern includes a plurality of stripes 610a, 610b, 610c, 610d, 610e, 610f, and 610g formed by the treatment. The stripes 610a, 610b, 610c, 610d, 610e, 610f, and 610g may be dimensioned according to one or more optimizations described above (e.g., in order to result in the target transmission FoV 615 according to one or more simulations). In some aspects, the pattern 610 may have a minimum width associated with the binary stripe pattern (e.g., such that stripe 610c in FIG. 6 represents a smallest possible stripe in the pattern 610). The minimum width may be selected to achieve the target transmission FoV 615. In other words, violation of the minimum width may result in the one or more radio frequencies failing to cover the target transmission FoV 615.

Any optimization described herein may refer to a local minimum (or maximum), even if estimated, approximated, and/or different than a global minimum (or maximum). By using techniques as described in connection with FIG. 6, the pattern 610 may result in the target transmission FoV 615, which improves service for UEs located within the target transmission FoV 615.

As indicated above, FIG. 6 is provided as an example. Other examples may differ from what is described with respect to FIG. 6.

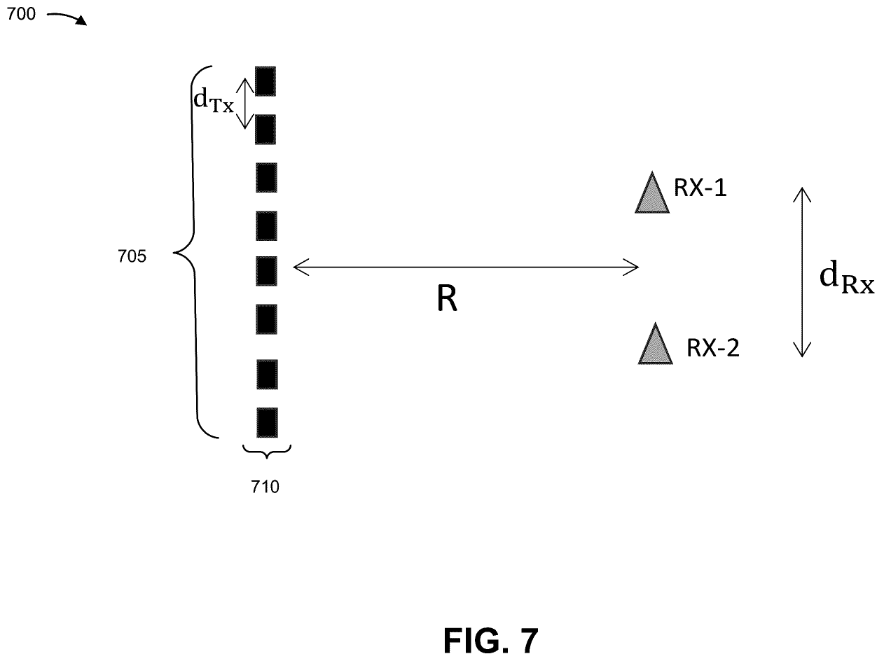

FIG. 7 is diagram illustrating an example 700 associated with multi-layer communications, in accordance with the present disclosure. As shown in FIG. 7, a transmit uniform linear array (ULA) 705 of a network node (e.g., a network node 110) may have a quantity of N antenna elements 710 having an inter-element spacing (d_{TX}). In some aspects, the transmit ULA 705 may enable LoS multi-layer communications. For example, a multi-layer communication may include an Nx1 channel response vector (h₁) for a transmission between the transmit ULA 705 and a receive antenna Rx-1, and an Nx1 channel response vector (h₂) for a transmission between the transmit ULA 705 and a receive antenna Rx-2. To enable the Rx-1 to—cancel out or suppress or treat as noise without significant penalty—the signal transmitted to the Rx-2 (e.g., via a sufficient condition E[h₁*h₂]=0,), the product of the transmit array inter-element spacing (d_{Tx}) and the distance (d_{Rx}) between the receive antennas Rx-1, Rx-2 may be equal to

$$\frac{R λ}{N} ,$$

where R is the distance between the transmit ULA 705 and the receive antennas Rx-1, Rx-2, and λ is the wavelength of the wireless signal (e.g., the multi-layer communication).

In some aspects, the inter-element spacing (d_{Tx}) may be equal to λ/2. In these cases, the distance between the receive antennas Rx-1, Rx-2 may be determined based on the following:

$${d}_{Rx} = \frac{2 R}{N} ⇒ E [ {h}_{1}^{*} {h}_{2} ] = 0 .$$

As an example, a distance (R) between the transmit ULA 705 and the receive antennas Rx-1, Rx-2 may be equal to forty meters (40m). For a transmit ULA having thirty-two antenna elements (N=32) with an inter-element spacing (d_{Tx}) equal to λ/2, a distance between the receive antennas Rx-1, Rx-2 may be equal to 2.5m (d_{TX}=2.5m).

As indicated above, FIG. 7 is provided as an example. Other examples may differ from what is described with respect to FIG. 7.

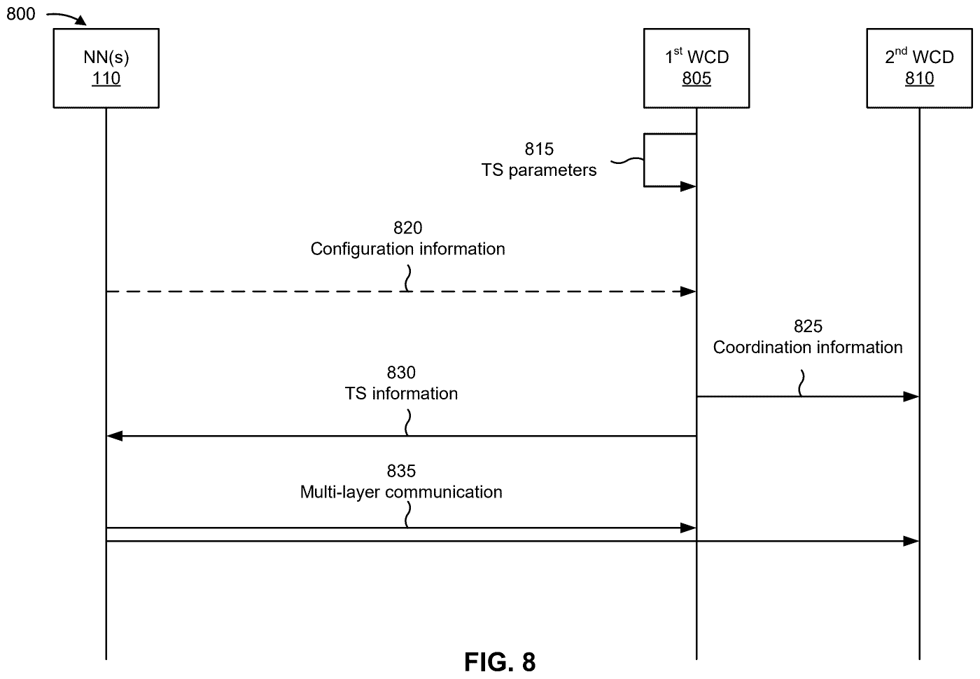

FIG. 8 is diagram illustrating an example 800 associated with transmissive surface enabled multi-layer communications, in accordance with the present disclosure. As shown in FIG. 8, a network node 110, a first wireless communication device 805 (e.g., 1^{st} WCD 805, as shown in FIG. 8), and a second wireless communication device 810 (e.g., 2^{nd} WCD 810, as shown in FIG. 8) may communicate with one another. In some aspects, the network node 110, the first wireless communication device 805, and the second wireless communication device 810 may be included in a wireless communication network, such as wireless communication network 100.

In some aspects, the multi-layer communication may include the network node 110 transmitting multiple data streams to the first wireless communication device 805 and/or the second wireless communication device 810 via a same frequency resource within a same polarization domain.

In some aspects, the network node 110 may have a direct LoS to the multiple transmissive surfaces. To enable the multi-layer communications, the first wireless communication device 805 may determine the set of TS parameters to ensure that in the wireless communication signals received by the first wireless communication device 805, the wireless communication signals intended for other devices (e.g., the second wireless communication device 810) can be canceled or suppressed or safely treated as noise without performance degradation.

As shown in FIG. 8, and by reference number 815, the first wireless communication device 805 may determine a set of transmissive surface parameters for receiving multi-layer communications from the network node 110 via one or more transmissive surfaces.

In some aspects, the set of transmissive surface parameters may include one or more parameters associated with the network node 110. For example, the set of transmissive surface parameters may include a distance (R) between the network node 110 and the one or more transmissive surfaces, a quantity (N) of antenna elements included in a ULA or antenna array of the network node 110, and/or an inter-element spacing of the antenna elements included in the ULA or antenna array of the network node 110, among other examples.

In some aspects, the first wireless communication device 805 may determine the one or more parameters associated with the network node 110 based at least in part on configuration information. For example, as shown by reference number 820, the network node 110 may transmit, and the first wireless communication device 805 may receive information indicating the distance (R) between the network node 110 and the one or more transmissive surfaces, the quantity of (N) antenna elements included in the ULA of the network node 110, and/or the inter-element spacing of the antenna elements included in the ULA of the network node 110.

In some aspects, the first wireless communication device 805 may determine the set of transmissive surface parameters based at least in part on a reference signal. For example, the first wireless communication device 805 may receive a reference signal transmitted by the network node 110 and may determine a cross transmissive surface interference associated with the multiple transmissive surfaces based at least in part on the reference signal. In some aspects, the reference signal comprises a CSI reference signal and/or a reference signal transmitted on an interference measurement resource.

In some aspects, the set of transmissive surface parameters may include a signal strength parameter associated with the first wireless communication device 805. For example, the first wireless communication device 805 may determine whether the first wireless communication device 805 is covered by the field of view of a first transmissive surface and/or whether the first wireless communication device 805 receives a wireless communication signal at a higher signal strength via the first transmissive surface relative to a signal strength of a wireless communication signal that is received via a second transmissive surface.

In some aspects, the first wireless communication device 805 may determine whether the first wireless communication device 805 is covered by the field of view of the first transmissive surface based at least in part on a location of the first wireless communication device 805 and/or a location to which the first transmissive surface is beam-focused. In some aspects, the first wireless communication device 805 may determine a location of the first wireless communication device 805 based at least in part on location information generated by the first wireless communication device 805, location information received from the network node 110, or location information received from another device, among other examples. Additionally, or alternatively, the first wireless communication device 805 may determine whether the first wireless communication device 805 is covered by the field of view of the first transmissive surface based at least in part on measuring a received signal strength at various locations and comparing the measured signal strengths in a manner similar to that described elsewhere herein.

In some aspects, the first wireless communication device 805 may determine a location to which the first transmissive surface is beam-focused based at least in part on determining that the first wireless communication device 805 is within the field of view of the first transmissive surface. Additionally, or alternatively, the first wireless communication device 805 may be configured with information indicating a location to which the first transmissive surface is beam-focused. For example, the configuration information received from the network node 110 may indicate a location of the first transmissive surface, a location to which the first transmissive surface is beam-focused, an area corresponding to the field of view of the first transmissive surface, and/or a received signal strength associated with the location to which the first transmissive surface is beam-focused, among other examples.

In some aspects, the set of transmissive surface parameters may include a signal strength parameter associated with the second wireless communication device 810. For example, the first wireless communication device 805 may determine whether the second wireless communication device 810 is covered by a field of view of the second transmissive surface and/or whether the second wireless communication device 810 receives a wireless communication signal at a relatively higher signal strength via the second transmissive surface relative to a signal strength of a wireless communication signal that is received via the first transmissive surface.

In some aspects, the first wireless communication device 805 may determine whether the second wireless communication device 810 is covered by the field of view of the second transmissive surface and/or whether the second wireless communication device 810 receives a wireless communication signal at a relatively higher signal strength via the second transmissive surface relative to a signal strength of a wireless communication signal that is received via the first transmissive surface based at least in part on information received from the second wireless communication device 810 (e.g., via a sidelink communication channel). For example, the second wireless communication device 810 may determine whether the second wireless communication device 810 is covered by the field of view of the second transmissive surface and/or whether the second wireless communication device 810 receives a wireless communication signal at a relatively higher signal strength via the second transmissive surface relative to a signal strength of a wireless communication signal that is received via the first transmissive surface in a manner similar to that described above with respect to the first wireless communication device 805. The second wireless communication device 810 may transmit information indicating whether the second wireless communication device 810 is covered by the field of view of the second transmissive surface and/or whether the second wireless communication device 810 receives a wireless communication signal at a relatively higher signal strength via the second transmissive surface relative to a signal strength of a wireless communication signal that is received via first transmissive surface to the first wireless communication device 805 via the sidelink communication channel.

In some aspects, the set of transmissive surface parameters may include a parameter indicating a quantity of uncorrelated streams that can be communicated via the one or more transmissive surfaces. In some aspects, the first wireless communication device 805 may determine the quantity of streams based at least in part on a number of transmissive surfaces via which the first wireless communication device 805 is able to receive wireless communication signals, a number of transmissive surfaces via which the second wireless communication device 810 is able to receive wireless communication signals, a signal strength parameter associated with the first wireless communication device 805, and/or a signal strength parameter associated with the second wireless communication device 810, among other examples.

As shown by reference number 825, the first wireless communication device 805 may transmit, and the second wireless communication device 810 may receive, coordination information. In some aspects, the coordination information is transmitted via a sidelink communication channel.

In some aspects, the coordination information may indicate an availability of receiving multi-layer communications. In some aspects, the coordination information may indicate one or more of the set of transmissive surface parameters determined by the first wireless communication device 805.

In some aspects, the coordination information indicates a TCI state associated with the multi-layer communication. In some aspects, the TCI state corresponds to a LoS path via a transmissive surface, of the multiple transmissive surfaces, or a dominant non-LoS path via the transmissive surface. In some aspects, the coordination information includes control information, beam attribute information, and/or configuration information.

As shown by reference number 830, the first wireless communication device 805 may transmit, and the network node 110 may receive, transmissive surface information. In some aspects, the transmissive surface information may indicate the availability of multiple antenna modules for communicating uncorrelated streams via multiple transmissive surfaces. In some aspects, the transmissive surface information may indicate a rank denoting a quantity of uncorrelated streams that can be communicated via multiple transmissive surfaces.

In some aspects, the transmissive surface information may indicate one or more parameters of the set of transmissive surface parameters determined by the first wireless communication device 805. For example, the transmissive surface information may indicate a location of the first wireless communication device 805 and/or a location of the second wireless communication device 810.

As shown by reference number 835, the network node 110 may transmit the multi-layer communication. In some aspects, the second wireless communication device 810 may receive the multi-layer communication via the one or more transmissive surfaces. In some aspects, the first wireless communication device 805 may receive the multi-layer communication via the one or more transmissive surfaces and may forward the multi-layer communication to the second wireless communication device 810 via the sidelink communication channel.

As indicated above, FIG. 8 is provided as an example. Other examples may differ from what is described with respect to FIG. 8.

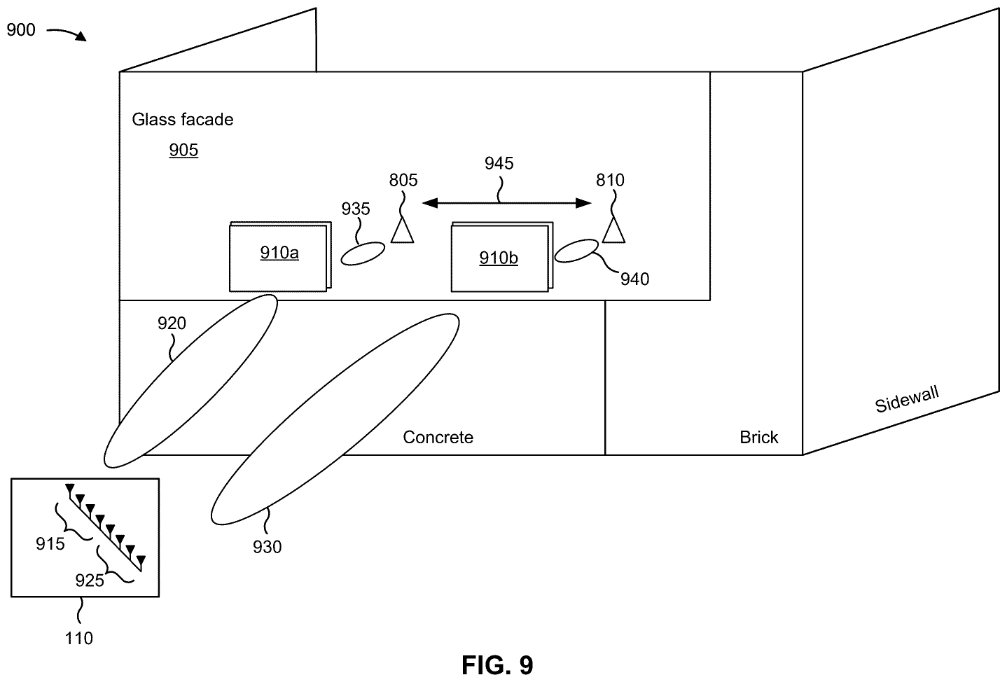

FIG. 9 is a diagram illustrating an example 900 associated with utilizing multiple transmissive surfaces to enable multi-layer communications, in accordance with the present disclosure. In some aspects, the first wireless communication device 805 and the second wireless communication device 810 may comprise a first UE (e.g., a first UE 120) and a second UE (e.g., a second UE 120), respectively.

In some aspects, the first wireless communication device 805 and the second wireless communication device 810 may be located within a facility (e.g., a building) that includes a surface 905. The surface 905 may be at least partially transparent to light. For example, as shown in FIG. 9, the surface 905 may comprise a glass façade of a building. As other examples, the surface 905 may comprise a window on a car or a train.

In some aspects, the surface 905 may include multiple transmissive surfaces. For example, as shown in FIG. 9, the surface 905 may include transmissive surface 910a and transmissive surface 910b. In some aspects, a first set of antenna elements 915 of the network node 110 may have a direct LoS (indicated by reference number 920 in FIG. 9) with transmissive surface 910a and a second set of antenna elements 925 may have a direct LoS (indicated by reference number 930 in FIG. 9) with transmissive surface 910b.

In some aspects, a distance (d) between the transmissive surface 910a and the transmissive surface 910b may enable multi-layer communications. In some aspects, the distance (d) between the transmissive surface 910a and the transmissive surface 910b may be configured to enable near-orthogonal communication channels to be seen by the first wireless communication device 805 and the second wireless communication device 810 based at least in part on the network node 110 being a distance (R) from the transmissive surface 910a and the transmissive surface 910b, and based at least in part on the network node 110 having a ULA or antenna array that includes a quantity of (N) antenna elements with an inter-element separation corresponding to one-half or any other particular fraction of the operating wavelength of the network node 110.

In some aspects, the distance (d) between the transmissive surface 910a and the transmissive surface 910b may enable spatial division multiplexed (SDM) transmission and/or reception between the network node 110, the first wireless communication device 805, and/or the second wireless communication device 810.

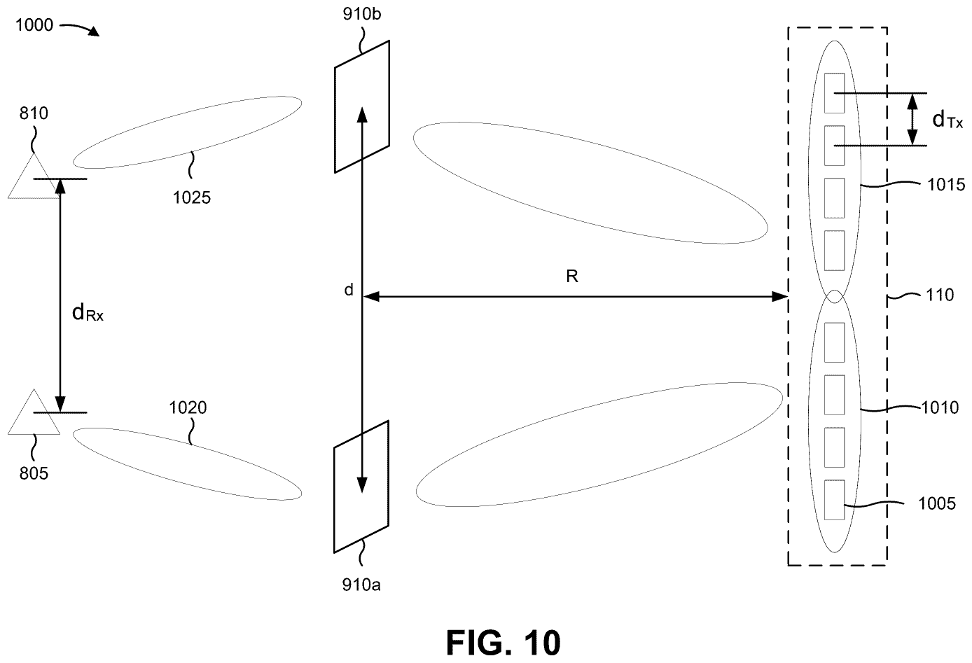

In some aspects, the transmissive surface 910a and the transmissive surface 910b may enable the first wireless communication device 805 and the second wireless communication device 810 to be simultaneously served by the network node 110 using the same RF beam. For example, the transmissive surface 910a and the transmissive surface 910b may enable the first wireless communication device 805 and the second wireless communication device 810 to be simultaneously served by the network node 110 using a rank-2 RF precoding via a partially connected hybrid architecture, as described in greater detail with respect to FIG. 10.

In some aspects, the transmissive surface 910a may be configured with a static pattern to cover a field of view 935. For example, the transmissive surface 910a may be configured with a static pattern to cover the field of view 935, in a manner similar to that described elsewhere herein.

In some aspects, the transmissive surface 910b may be configured with a static pattern to cover a field of view 940. For example, the transmissive surface 910b may be configured with a static pattern to cover the field of view 940, in a manner similar to that described elsewhere herein.

In some aspects, each wireless communication device (e.g., first wireless communication device 805 and second wireless communication device 810) may be served by one network node 110. As shown in FIG. 9, the first wireless communication device 805 may be within a field of view 935 of the first transmissive surface 910a and may be served by the first transmissive surface 910a. The second wireless communication device 810 may be within a field of view 940 of the second transmissive surface 910b and may be served by the transmissive surface 910b.

In some aspects, the first wireless communication device 805 and the second wireless communication device 810 may communicate via a sidelink communication channel (indicated by reference number 945, in FIG. 9). In some aspects, the first wireless communication device 805 and the second wireless communication device 810 may utilize the sidelink communication channel to exchange transmissive surface parameters, beam configuration information, beam attributes (e.g., for one or more SSB beams), and/or control information, among other examples.

In some aspects, the first wireless communication device 805 (or the second wireless communication device 810) may receive, from the network node 110 and via the transmissive surface 910a, a communication (e.g., a control message) to be forwarded to the second wireless communication device 810. The first wireless communication device 805 (or the second wireless communication device 810) may forward the received communication to the second wireless communication device 810 via the sidelink communication channel.

As indicated above, FIG. 9 is provided as an example. Other examples may differ from what is described with respect to FIG. 9.

FIG. 10 is a diagram illustrating an example 1000 associated with a partially connected hybrid architecture, in accordance with the present disclosure. As shown in FIG. 10, the network node 110 may include a transmit ULA that includes a quantity of (N) antenna elements 1005 (e.g., eight antenna elements as shown in FIG. 10). In some aspects, the network node 110 may include a transmit rectangular or square antenna array that includes a quantity of (N) antenna elements along one of its dimensions. In some aspects, the network node 110 may be a distance (R) from the transmissive surface 910a and the transmissive surface 910b.

In some aspects, a first set of antenna elements 1005 may correspond to a first RF chain 1010 and a second set of antenna elements 1005 may correspond to a second RF chain 1015.

In some aspects, the transmissive surface 910a and the transmissive surface 910b may be patterned to cover fields of view 1020, 1025, respectively. In some aspects, the transmissive surface 910a may be configured to beam focus to a first location (e.g., a location corresponding to the center of the field of view 1020) and the transmissive surface 910b may be configured to beam focus to a second location (e.g., a location corresponding to the center of the field of view 1025).

In some aspects, to enable multi-layer communications, the first wireless communication device 805 may be covered by the field of view 1020 to cause the first wireless communication device 805 to receive a wireless communication signal at a relatively higher signal strength via the transmissive surface 910a relative to a signal strength of a wireless communication signal that is received via transmissive surface 910b. Similarly, the second wireless communication device 810 may be covered by the field of view 1025 to cause the second wireless communication device 810 to receive a wireless communication signal at a relatively higher signal strength via the transmissive surface 910b relative to a signal strength of a wireless communication signal that is received via transmissive surface 910a.

As indicated above, FIG. 10 is provided as an example. Other examples may differ from what is described with respect to FIG. 10.

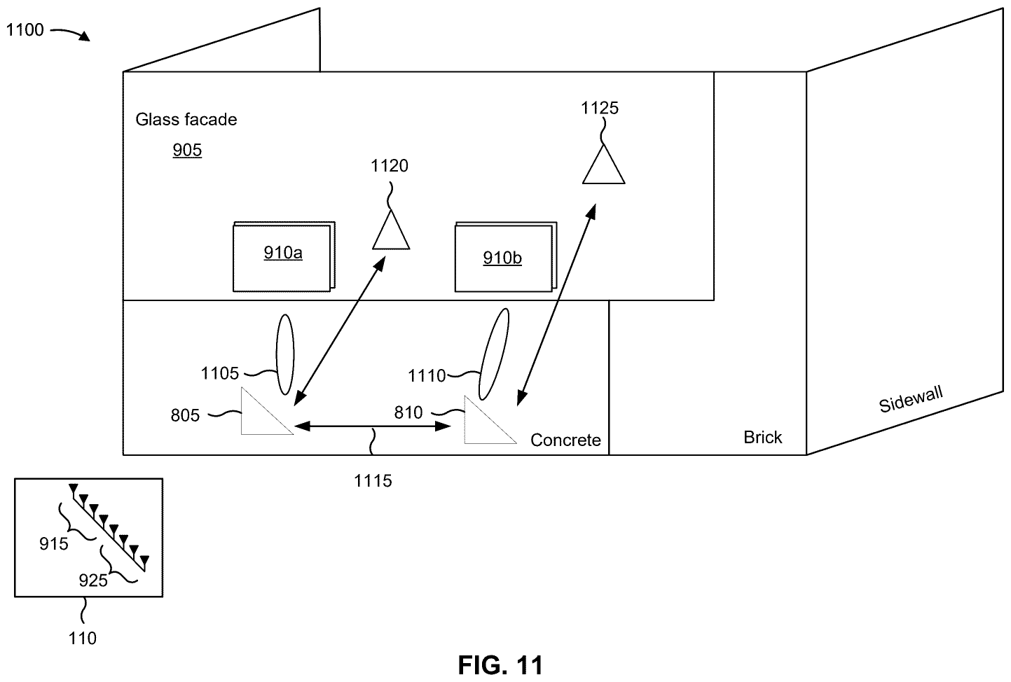

FIG. 11 is a diagram illustrating an example 1100 associated with utilizing multiple transmissive surfaces to enable multi-layer communications, in accordance with the present disclosure. In some aspects, the first wireless communication device 805 and the second wireless communication device 810 may comprise a first customer premises equipment (CPE) and a second CPE, respectively. For example, the first wireless communication device 805 and the second wireless communication device 810 may comprise a relay device, a wireless access point, or another type of device that is configured to relay wireless communications between the transmissive surface 910a and/or the transmissive surface 910b and one or more other wireless communication devices (e.g., a UE 120, a CPE, or the like).

In some aspects, the first wireless communication device 805 and the second wireless communication device 810 may be non-mobile or semi-static wireless communication devices. For example, the first wireless communication device 805 and the second wireless communication device 810 may be installed or positioned at a fixed location within a building.

In some aspects, the first wireless communication device 805 and the second wireless communication device 810 may establish a sidelink communication channel 1115 for communicating data between the first wireless communication device 805 and the second wireless communication device 810. In some aspects, the data may include beam configuration information, beam attributes, and/or control information, among other types of information.

In some aspects, the first wireless communication device 805 may be located within a field of view 1105 of the transmissive surface 910a. For example, the transmissive surface 910a may be configured with a static pattern to beam-focus toward the location of the first wireless communication device 805.

In some aspects, the first wireless communication device 805 may be configured to receive multi-layer communications via the transmissive surface 910a and the 910b. For example, the first wireless communication device 805 may be configured to receive multi-layer communications via the transmissive surfaces 910a and 910b in a manner similar to that described elsewhere herein.

In some aspects, the first wireless communication device 805 may transmit the received communications to a device located within a coverage area of the first wireless communication device 805. For example, as shown in FIG. 10, the first wireless communication device 805 may forward the received communications to a wireless device 1120. In some aspects, the first wireless communication device 805 may receive a communication from the wireless communication device 1120 and may forward the received communication to the network node 110 via the transmissive surface 910a and/or the transmissive surface 910b.

In some aspects, the second wireless communication device 810 may be located within a field of view 1110 of the transmissive surface 910b. For example, the transmissive surface 910b may be configured with a static pattern to beam-focus toward the location of the second wireless communication device 810.

In some aspects, the second wireless communication device 810 may be configured to receive multi-layer communications via the transmissive surface 910a and the 910b. For example, the second wireless communication device 810 may be configured to receive multi-layer communications via the transmissive surface 910a and the 910b in a manner similar to that described elsewhere herein.

In some aspects, the second wireless communication device 810 may transmit the received communications to a device located within a coverage area of the second wireless communication device 810. For example, as shown in FIG. 10, the second wireless communication device 810 may forward the received communications to a wireless device 1125. In some aspects, the second wireless communication device 810 may receive a communication from the wireless communication device 1125 and may forward the received communication to the network node 110 via the transmissive surface 910b and/or the transmissive surface 910a.

As indicated above, FIG. 11 is provided as an example. Other examples may differ from what is described with respect to FIG. 11.

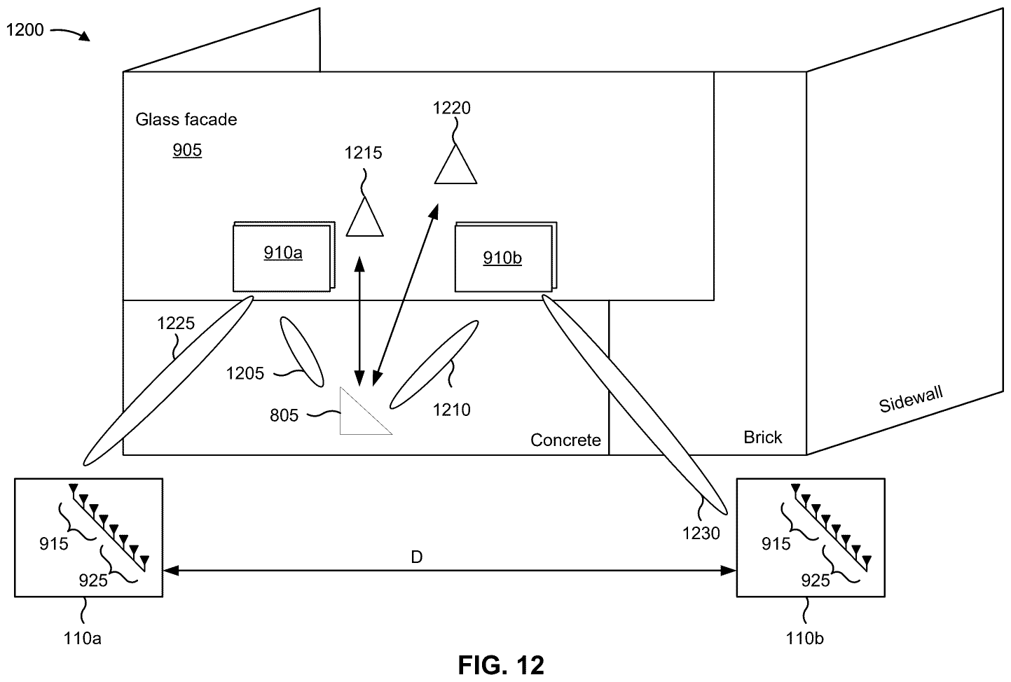

FIG. 12 is a diagram illustrating an example 1200 associated with utilizing multiple transmissive surfaces to enable multi-layer communications, in accordance with the present disclosure. In some aspects, a single wireless communication device (e.g., the first wireless communication device 805, as shown in FIG. 12) may be serviced by multiple network nodes 110. For example, as shown in FIG. 12, the first wireless communication device 805 may comprise a CPE configured to receive multi-layer communications from a first network node 110a and a second network node 110b.

In some aspects, the first network node 110a may be in direct LoS with transmissive surface 910a (indicated by reference number 1225 in FIG. 12) and the second network node 110b may be in direct LoS with transmissive surface 910b (indicated by reference number 1230 in FIG. 12). In some aspects, the transmissive surface 910a and the transmissive surface 910b may enable the first wireless communication device 805 to be simultaneously served by the first network node 110a and the second network node 110b using different RF beams. For example, the transmissive surface 910a and the transmissive surface 910b may enable the first wireless communication device 805 to be simultaneously served by the first network node 110a and the second network node 110b using a rank-2 RF precoding (across first network node 110a and the second network node 110b) via a fully or partially connected hybrid architecture.

In some aspects, the first network node 110a and the second network node 110b may be separated by a distance (D). In some aspects, the distance (D) may enable multi-layer SDM transmission from both the first network node 110a and the second network node 110b. In these aspects, there may not be any constraint with respect to the distance between the transmissive surface 910a and the transmissive surface 910b.

In some aspects, the first wireless communication device 805 may be a non-mobile or semi-static wireless communication device. For example, the first wireless communication device 805 may be installed or positioned at a fixed location within a building.

In some aspects, the first wireless communication device 805 may be located within a field of view 1205 of the transmissive surface 910a and within a field of view 1210 of the transmissive surface 910b. For example, the transmissive surface 910a and the transmissive surface 910b may be configured with a static pattern to beam-focus toward the location of the first wireless communication device 805.

In some aspects, the first wireless communication device 805 may receive multi-layer communications from the first network node 110a and the second network node 110b via the transmissive surface 910a and the transmissive surface 910b and may forward the communications to one or more wireless communication devices (e.g., wireless communication devices 1215, 1220, as shown in FIG. 12) located within a coverage area of the first wireless communication device 805. In some aspects, the first wireless communication device 805 may receive communications from one or more wireless communication devices located within the coverage area of the first wireless communication device 805 and may forward the communications to the first network node 110a and/or the second network node 110b via the transmissive surface 910a and/or the transmissive surface 910b.

As indicated above, FIG. 12 is provided as an example. Other examples may differ from what is described with respect to FIG. 12.

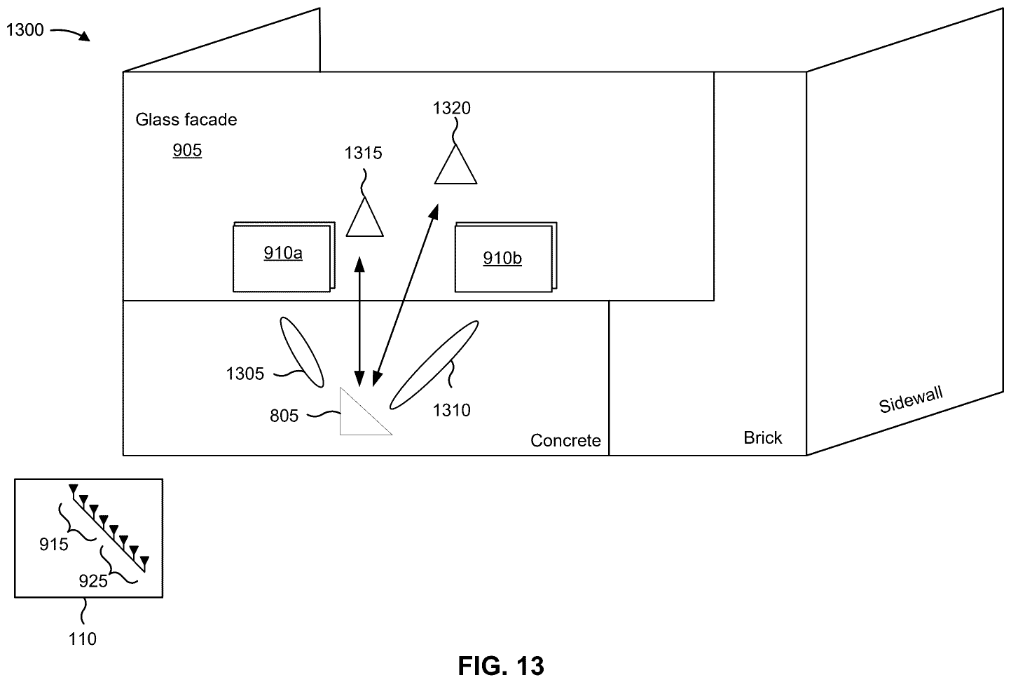

FIG. 13 is a diagram illustrating an example 1300 associated with utilizing multiple transmissive surfaces to enable multi-layer communications, in accordance with the present disclosure. In some aspects, a single wireless communication device (e.g., the first wireless communication device 805, as shown in FIG. 13) may be serviced by a single network node 110. For example, as shown in FIG. 13, the first wireless communication device 805 may comprise a CPE configured to receive multi-layer communications from the network node 110.

In some aspects, the network node 110 may be in direct LoS with transmissive surface 910a and with transmissive surface 910b. For example, the network node 110 may be in direct LoS with transmissive surface 910a and with transmissive surface 910b in a manner similar to that described elsewhere herein. In some aspects, the transmissive surface 910a and the transmissive surface 910b may enable the first wireless communication device 805 to be served by the network node 110 using the same RF beams. For example, the transmissive surface 910a and the transmissive surface 910b may enable the first wireless communication device 805 to be served by the network node 110 using a rank-2 RF precoding via a partially connected hybrid architecture.

In some aspects, the first wireless communication device 805 may be a non-mobile or semi-static wireless communication device. For example, the first wireless communication device 805 may be installed or positioned at a fixed location within a building.

In some aspects, a first antenna module of the first wireless communication device 805 may be located within a field of view 1305 of the transmissive surface 910a, and a second antenna module of the first wireless communication device 805 may be located within a field of view 1310 of the transmissive surface 910b. For example, the transmissive surface 910a and the transmissive surface 910b may be configured with a static pattern to beam-focus toward the location of the first wireless communication device 805.

In some aspects, a distance between the first antenna module and the second antenna module may enable the first wireless communication device 805 to utilize multi-layer communications. In some aspects, the distance (d) between the transmissive surface 910a and the transmissive surface 910b may correspond to

$$d = \frac{2 R}{N} .$$

In some aspects, the distance between the first antenna module and the second antenna module may correspond to

$$\frac{λ {d}_{TS}^{RX}}{2 d} , where {d}_{TS}^{RX}$$

is the distance between the first wireless communication device 805 and the transmissive surfaces 910a, 910b. In some aspects, the distance (d) and the distance

$${d}_{TS}^{RX}$$

may enable a well-conditioned cascade channel (of rank-at-least (2) to be seen across the first antenna and the second antenna module via the transmissive surfaces 910a, 910b, from the network node 110 at a distance (R) from the transmissive surfaces 910a, 910b with an N element transmit ULA or other antenna array with a λ/2 inter-element separation.

In some aspects, the first wireless communication device 805 may receive multi-layer communications from the network node 110 via the transmissive surface 910a and the transmissive surface 910b and may forward the communications to one or more wireless communication devices (e.g., wireless communication devices 1315, 1320, as shown in FIG. 13) located within a coverage area of the first wireless communication device 805. In some aspects, the first wireless communication device 805 may receive communications from one or more wireless communication devices located within the coverage area of the first wireless communication device 805 and may forward the communications to the network node 110 via the transmissive surface 910a and/or the transmissive surface 910b.

As indicated above, FIG. 13 is provided as an example. Other examples may differ from what is described with respect to FIG. 13.

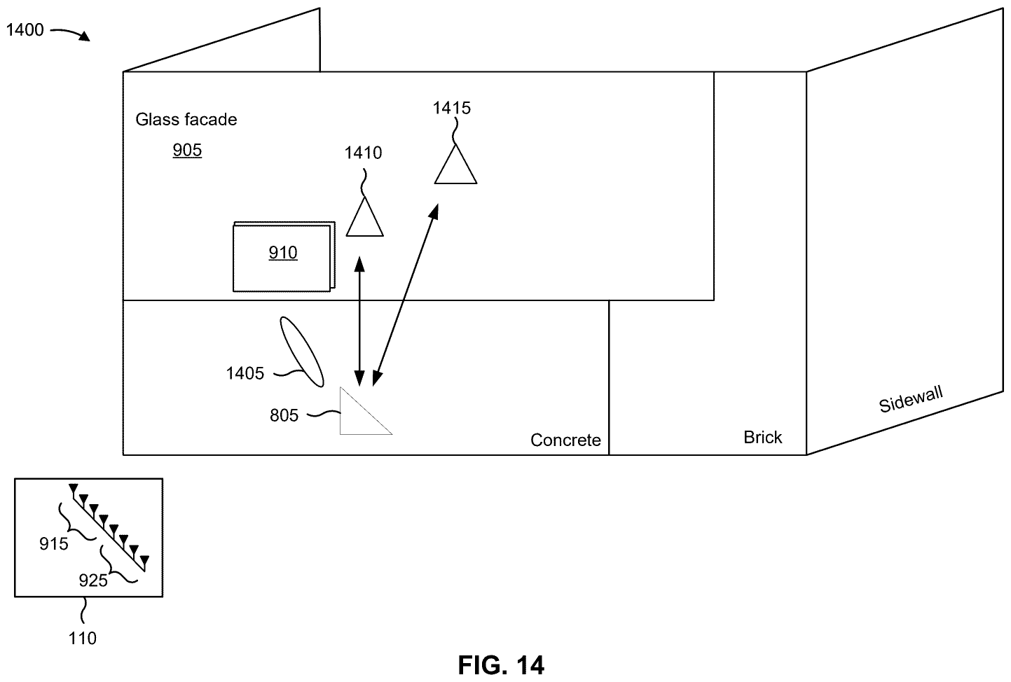

FIG. 14 is a diagram illustrating an example 1400 associated with utilizing a single transmissive surface to enable multi-layer communications, in accordance with the present disclosure. In some aspects, a single wireless communication device (e.g., the first wireless communication device 805, as shown in FIG. 14) may be serviced by a single network node 110. For example, as shown in FIG. 14, the first wireless communication device 805 may comprise a CPE configured to receive multi-layer communications from the network node 110.

In some aspects, the network node 110 may be in direct LoS with transmissive surface 910. For example, the network node 110 may be in direct LoS with transmissive surface 910 in a manner similar to that described elsewhere herein.

In some aspects, the transmissive surface 910 may be configured with a phase profile that achieves aperture magnification. For example, a design profile of the transmissive surface 910 may compensate for the incident and departing wave curvatures to achieve a lensing magnification effect.

In some aspects, the phase profile of the transmissive surface 910 may be a beam-focusing profile that assumes a virtual transmitter at a center of the network node 110 and a virtual receiver at a center of the first wireless communication device 805. In some aspects, the aperture magnification may enable multi-layer communications by causing the effective cascade channel between the network node 110 and the first wireless communication device 805 to have a higher rank.

In some aspects, the first wireless communication device 805 may be located within a field of view 1405 of the transmissive surface 910. For example, the transmissive surface 910 may be configured with a static pattern to beam-focus toward the location of the first wireless communication device 805.

In some aspects, the first wireless communication device 805 may receive multi-layer communications from the network node 110 via the transmissive surface 910 and may forward the communications to one or more wireless communication devices (e.g., wireless communication devices 1410, 1415, as shown in FIG. 14) located within a coverage area of the first wireless communication device 805. In some aspects, the first wireless communication device 805 may receive communications from one or more wireless communication devices located within the coverage area of the first wireless communication device 805 and may forward the communications to the network node 110 via the transmissive surface 910.

As indicated above, FIG. 14 is provided as an example. Other examples may differ from what is described with respect to FIG. 14.

FIG. 15 is a diagram illustrating an example process 1500 performed, for example, at a first wireless communication device or an apparatus of a first wireless communication device, in accordance with the present disclosure. Example process 1500 is an example where the apparatus or the first wireless communication device (e.g., first wireless communication device 805) performs operations associated with transmissive surface enabled multi-layer communications.

As shown in FIG. 15, in some aspects, process 1500 may include transmitting, to a second wireless communication device, coordination information associated with receiving a multi-layer communication from a network node via multiple transmissive surfaces (block 1510). For example, the first wireless communication device (e.g., using transmission component 1904 and/or communication manager 150, depicted in FIG. 19) may transmit, to a second wireless communication device, coordination information associated with receiving a multi-layer communication from a network node via multiple transmissive surfaces, as described above.

As further shown in FIG. 15, in some aspects, process 1500 may include receiving the multi-layer communication from the network node via the multiple transmissive surfaces (block 1520). For example, the first wireless communication device (e.g., using reception component 1902 and/or communication manager 150, depicted in FIG. 19) may receive the multi-layer communication from the network node via the multiple transmissive surfaces, as described above.

Process 1500 may include additional aspects, such as any single aspect or any combination of aspects described below and/or in connection with one or more other processes described elsewhere herein.

In a first aspect, the first wireless communication device comprises a first UE and the second wireless communication device comprises a second UE.

In a second aspect, the first wireless communication device comprises a first UE and the second wireless communication device comprises a CPE.

In a third aspect, the first wireless communication device comprises a first CPE and the second wireless communication device comprises a second CPE.

In a fourth aspect, the first wireless communication device comprises a CPE and the second wireless communication device comprises a UE.

In a fifth aspect, the coordination information indicates a TCI state associated with the multi-layer communication.

In a sixth aspect, the TCI state corresponds to an LoS path via a transmissive surface, of the multiple transmissive surfaces, or a dominant non-LoS path via the transmissive surface.

In a seventh aspect, the coordination information includes control information, beam attribute information, configuration information, or a combination thereof.

In an eighth aspect, the coordination information is transmitted via a sidelink communication channel.

In a ninth aspect, process 1500 includes measuring or processing a reference signal, wherein a cross transmissive surface interference associated with the multiple transmissive surfaces is determined based at least in part on the reference signal.

In a tenth aspect, the reference signal comprises a CSI reference signal, a reference signal transmitted on an interference measurement resource, or a combination thereof.

In an eleventh aspect, a distance between the multiple transmissive surfaces enables multi-layer spatial division multiplex communications between the first wireless communication device and the network node.

In a twelfth aspect, the first wireless communication device and the second wireless communication device are served using a same radio frequency beam.

In a thirteenth aspect, a distance between the multiple transmissive surfaces is based at least in part on a distance between a location of the multiple transmissive surfaces and a location of the network node.

In a fourteenth aspect, the distance between the multiple transmissive surfaces is further based at least in part on a quantity of elements included in an antenna array of the network node.

In a fifteenth aspect, the multiple transmissive surfaces are configured to direct the multi-layer communication toward one or more other wireless communication devices and the first wireless communication device receives the multi-layer communication from the one or more other wireless communication devices.

In a sixteenth aspect, the one or more other wireless communication devices comprise a UE, a relay, a CPE, or a combination thereof.

In a seventeenth aspect, process 1500 includes forwarding, via a sidelink communication channel, the multi-layer communication to the second wireless communication device.

In an eighteenth aspect, the multi-layer communication is received from a plurality of network nodes.

In a nineteenth aspect, process 1500 includes receiving, via a sidelink communication channel, a communication from the second wireless communication device, and forwarding the communication to the network node via a transmissive surface of the multiple transmissive surfaces.

In a twentieth aspect, the communication comprises a control message.

In a twenty-first aspect, process 1500 includes receiving a control message from the network node via one or more of the multiple transmissive surfaces, and forwarding, via a sidelink communication channel, the control message to the second wireless communication device.

In a twenty-second aspect, the first wireless communication device comprises multiple antenna modules, process 1500 includes transmitting, to the network node, an indication of an availability of the multiple antenna modules for communicating uncorrelated streams via the multiple transmissive surfaces.

In a twenty-third aspect, the indication is transmitted based at least in part on determining a distance between the network node and the multiple transmissive surfaces, a distance between the first wireless communication device and the multiple transmissive surfaces, a distance between adjacent transmissive surfaces of the multiple transmissive surfaces, or a combination thereof.

In a twenty-fourth aspect, a transmissive surface, of the multiple transmissive surfaces, is patterned with a phase profile to achieve aperture magnification.

In a twenty-fifth aspect, the aperture magnification is achieved based at least in part on a beam-focusing pattern that assumes a source at a first reference position associated with an antenna array of the network node and a receiver at a second reference position associated with an antenna array of the first wireless communication device.

In a twenty-sixth aspect, the first reference position comprises a center of the antenna array of the network node, the second reference position comprises a center of the antenna array of the first wireless communication device, or a combination thereof.

In a twenty-seventh aspect, the transmissive surface is patterned to compensate for curvatures on incident and refracted wavefronts associated with the transmissive surface.

In a twenty-eighth aspect, process 1500 includes transmitting, to the network node, an indication of a quantity of uncorrelated streams that can be communicated via the multiple transmissive surfaces.

Although FIG. 15 shows example blocks of process 1500, in some aspects, process 1500 may include additional blocks, fewer blocks, different blocks, or differently arranged blocks than those depicted in FIG. 15. Additionally, or alternatively, two or more of the blocks of process 1500 may be performed in parallel.

FIG. 16 is a diagram illustrating an example process 1600 performed, for example, at a wireless communication device or an apparatus of a wireless communication device, in accordance with the present disclosure. Example process 1600 is an example where the apparatus or the wireless communication device (e.g., wireless communication device 805) performs operations associated with transmissive surface enabled multi-layer communications.

As shown in FIG. 16, in some aspects, process 1600 may include transmitting, to a network node, information indicating an availability of multiple antenna modules for communicating uncorrelated streams via multiple transmissive surfaces (block 1610). For example, the wireless communication device (e.g., using transmission component 1904 and/or communication manager 1906, depicted in FIG. 19) may transmit, to a network node, information indicating an availability of multiple antenna modules for communicating uncorrelated streams via multiple transmissive surfaces, as described above.

As further shown in FIG. 16, in some aspects, process 1600 may include receiving a multi-layer communication from the network node via the multiple transmissive surfaces (block 1620). For example, the wireless communication device (e.g., using reception component 1902 and/or communication manager 1906, depicted in FIG. 19) may receive a multi-layer communication from the network node via the multiple transmissive surfaces, as described above.

Process 1600 may include additional aspects, such as any single aspect or any combination of aspects described below and/or in connection with one or more other processes described elsewhere herein.

In a first aspect, process 1600 includes transmitting, to another wireless communication device, coordination information associated with receiving the multi-layer communication from the network node via the multiple transmissive surfaces.

In a second aspect, the wireless communication device comprises a first UE and the other wireless communication device comprises a CPE.

In a third aspect, the wireless communication device comprises a first CPE and the other wireless communication device comprises a second CPE.

In a fourth aspect, the wireless communication device comprises a CPE and the other wireless communication device comprises a UE.

In a fifth aspect, the coordination information indicates a TCI state associated with the multi-layer communication.

In a sixth aspect, the TCI state corresponds to an LoS path via a transmissive surface, of the multiple transmissive surfaces, or a dominant non-LoS path via the transmissive surface.

In a seventh aspect, the coordination information includes control information, beam attribute information, configuration information, or a combination thereof.

In an eighth aspect, the coordination information is transmitted via a sidelink communication channel.

In a ninth aspect, the wireless communication device and the other wireless communication device are served using a same radio frequency beam.

In a tenth aspect, process 1600 includes measuring a reference signal, wherein a cross transmissive surface interference associated with the multiple transmissive surfaces is determined based at least in part on the reference signal.

In an eleventh aspect, the reference signal comprises a CSI reference signal, a reference signal transmitted via an interference measurement resource, or a combination thereof.

In a twelfth aspect, a distance between the multiple transmissive surfaces enables multi-layer spatial division multiplex communications between the first wireless communication device and the network node.

In a thirteenth aspect, a distance between the multiple transmissive surfaces is based at least in part on a distance between a location of the multiple transmissive surfaces and a location of the network node.

In a fourteenth aspect, the distance between the multiple transmissive surfaces is further based at least in part on a quantity of elements included in an antenna array of the network node.

In a fifteenth aspect, the multiple transmissive surfaces are configured to direct the multi-layer communication toward one or more other wireless communication devices and the wireless communication device receives the multi-layer communication from the one or more other wireless communication devices.

In a sixteenth aspect, the one or more other wireless communication devices comprise a UE, a relay, a CPE, or a combination thereof.

In a seventeenth aspect, process 1600 includes forwarding, via a sidelink communication channel, the multi-layer communication to another wireless communication device.

In an eighteenth aspect, the multi-layer communication is received from a plurality of network nodes.

In a nineteenth aspect, process 1600 includes receiving, via a sidelink communication channel, a communication from another wireless communication device, and forwarding the communication to the network node via a transmissive surface of the multiple transmissive surfaces.

In a twentieth aspect, the communication comprises a control message.

In a twenty-first aspect, process 1600 includes receiving a control message from the network node via one or more of the multiple transmissive surfaces, and forwarding, via a sidelink communication channel, the control message to another wireless communication device.

In a twenty-second aspect, the information indicating the availability of the multiple antenna modules for communicating the uncorrelated streams via the multiple transmissive surfaces is transmitted based at least in part on determining a distance between the network node and the multiple transmissive surfaces, a distance between the wireless communication device and the multiple transmissive surfaces, a distance between adjacent transmissive surfaces of the multiple transmissive surfaces, or a combination thereof.

In a twenty-third aspect, a transmissive surface, of the multiple transmissive surfaces, is patterned with a phase profile to achieve aperture magnification.

In a twenty-fourth aspect, the aperture magnification is achieved based at least in part on a beam-focusing pattern that assumes a source at a first reference position associated with an antenna array of the network node and a receiver at a second reference position associated with an antenna array of the wireless communication device.

In a twenty-fifth aspect, the first reference position comprises a center of the antenna array of the network node, the second reference position comprises a center of the antenna array of the wireless communication device, or a combination thereof.

In a twenty-sixth aspect, the transmissive surface is patterned to compensate for curvatures on incident and refracted wavefronts associated with the transmissive surface.

In a twenty-seventh aspect, process 1600 includes transmitting, to the network node, an indication of a quantity of uncorrelated streams that can be communicated via the multiple transmissive surfaces.

Although FIG. 16 shows example blocks of process 1600, in some aspects, process 1600 may include additional blocks, fewer blocks, different blocks, or differently arranged blocks than those depicted in FIG. 16. Additionally, or alternatively, two or more of the blocks of process 1600 may be performed in parallel.

FIG. 17 is a diagram illustrating an example process 1700 performed, for example, at a wireless communication device or an apparatus of a wireless communication device, in accordance with the present disclosure. Example process 1700 is an example where the apparatus or the wireless communication device (e.g., wireless communication device 805) performs operations associated with transmissive surface enabled multi-layer communications.

As shown in FIG. 17, in some aspects, process 1700 may include transmitting, to a network node, information indicating a rank denoting a quantity of uncorrelated streams that can be communicated via multiple transmissive surfaces (block 1710). For example, the wireless communication device (e.g., using transmission component 1904 and/or communication manager 1906, depicted in FIG. 19) may transmit, to a network node, information indicating a rank denoting a quantity of uncorrelated streams that can be communicated via multiple transmissive surfaces, as described above.

As further shown in FIG. 17, in some aspects, process 1700 may include receiving a multi-layer communication from the network node via the multiple transmissive surfaces (block 1720). For example, the wireless communication device (e.g., using reception component 1902 and/or communication manager 1906, depicted in FIG. 19) may receive a multi-layer communication from the network node via the multiple transmissive surfaces, as described above.

Process 1700 may include additional aspects, such as any single aspect or any combination of aspects described below and/or in connection with one or more other processes described elsewhere herein.

In a first aspect, process 1700 includes transmitting, to another wireless communication device, coordination information associated with receiving the multi-layer communication from the network node via the multiple transmissive surfaces.

In a second aspect, the wireless communication device comprises a first UE and the other wireless communication device comprises a CPE.

In a third aspect, the wireless communication device comprises a first CPE and the other wireless communication device comprises a second CPE.

In a fourth aspect, the wireless communication device comprises a CPE and the other wireless communication device comprises a UE.

In a fifth aspect, the coordination information indicates a TCI state associated with the multi-layer communication.

In a sixth aspect, the TCI state corresponds to an LoS path via a transmissive surface, of the multiple transmissive surfaces, or a dominant non-LoS path via the transmissive surface.

In a seventh aspect, the coordination information includes control information, beam attribute information, configuration information, or a combination thereof.

In an eighth aspect, the coordination information is transmitted via a sidelink communication channel.

In a ninth aspect, the wireless communication device and the other wireless communication device are served using a same radio frequency beam.

In a tenth aspect, process 1700 includes measuring a reference signal, wherein a cross transmissive surface interference associated with the multiple transmissive surfaces is determined based at least in part on the reference signal.

In an eleventh aspect, the reference signal comprises a CSI reference signal, a reference signal transmitted via an interference measurement resource, or a combination thereof.

In a twelfth aspect, a distance between the multiple transmissive surfaces enables multi-layer spatial division multiplex communications between the first wireless communication device and the network node.

In a thirteenth aspect, a distance between the multiple transmissive surfaces is based at least in part on a distance between a location of the multiple transmissive surfaces and a location of the network node.

In a fourteenth aspect, the distance between the multiple transmissive surfaces is further based at least in part on a quantity of elements included in an antenna array of the network node.

In a fifteenth aspect, the multiple transmissive surfaces are configured to direct the multi-layer communication toward one or more other wireless communication devices and the wireless communication device receives the multi-layer communication from the one or more other wireless communication devices.

In a sixteenth aspect, the one or more other wireless communication devices comprise a UE, a relay, a CPE, or a combination thereof.

In a seventeenth aspect, process 1700 includes forwarding, via a sidelink communication channel, the multi-layer communication to another wireless communication device.

In an eighteenth aspect, the multi-layer communication is received from a plurality of network nodes.

In a nineteenth aspect, process 1700 includes receiving, via a sidelink communication channel, a communication from another wireless communication device, and forwarding the communication to the network node via a transmissive surface of the multiple transmissive surfaces.

In a twentieth aspect, the communication comprises a control message.

In a twenty-first aspect, process 1700 includes receiving a control message from the network node via one or more of the multiple transmissive surfaces, and forwarding, via a sidelink communication channel, the control message to another wireless communication device.

In a twenty-second aspect, the wireless communication device comprises multiple antenna modules, and process 1700 includes transmitting, to the network node, an indication of an availability of the multiple antenna modules for communicating uncorrelated streams via the multiple transmissive surfaces.

In a twenty-third aspect, the indication is transmitted based at least in part on determining a distance between the network node and the multiple transmissive surfaces, a distance between the wireless communication device and the multiple transmissive surfaces, a distance between adjacent transmissive surfaces of the multiple transmissive surfaces, or a combination thereof.

In a twenty-fourth aspect, a transmissive surface, of the multiple transmissive surfaces, is patterned with a phase profile to achieve aperture magnification.

In a twenty-fifth aspect, the aperture magnification is achieved based at least in part on a beam-focusing pattern that assumes a source at a first reference position associated with an antenna array of the network node and a receiver at a second reference position associated with an antenna array of the wireless communication device.

In a twenty-sixth aspect, the first reference position comprises a center of the antenna array of the network node, the second reference position comprises a center of the antenna array of the wireless communication device, or a combination thereof.

In a twenty-seventh aspect, the transmissive surface is patterned to compensate for curvatures on incident and refracted wavefronts associated with the transmissive surface.

Although FIG. 17 shows example blocks of process 1700, in some aspects, process 1700 may include additional blocks, fewer blocks, different blocks, or differently arranged blocks than those depicted in FIG. 17. Additionally, or alternatively, two or more of the blocks of process 1700 may be performed in parallel.

FIG. 18 is a diagram illustrating an example process 1800 performed, for example, at a network node or an apparatus of a network node, in accordance with the present disclosure. Example process 1800 is an example where the apparatus or the network node (e.g., network node 110) performs operations associated with transmissive surface enabled multi-layer communications.

As shown in FIG. 18, in some aspects, process 1800 may include receiving an indication of a location of a UE within a facility (block 1810). For example, the network node (e.g., using reception component 2002 and/or communication manager 2006, depicted in FIG. 20) may receive an indication of a location of a UE within a facility, as described above.

As further shown in FIG. 18, in some aspects, process 1800 may include transmitting a multi-layer communication to the UE via a transmissive surface on the facility based at least in part on the location of the UE, wherein the transmissive surface is patterned with a phase profile to achieve aperture magnification (block 1820). For example, the network node (e.g., using transmission component 2004 and/or communication manager 2006, depicted in FIG. 20) may transmit a multi-layer communication to the UE via a transmissive surface on the facility based at least in part on the location of the UE, wherein the transmissive surface is patterned with a phase profile to achieve aperture magnification, as described above.

Process 1800 may include additional aspects, such as any single aspect or any combination of aspects described below and/or in connection with one or more other processes described elsewhere herein.

In one aspect, the transmissive surface is patterned to compensate for curvatures on incident and refracted wavefronts associated with the transmissive surface.

Although FIG. 18 shows example blocks of process 1800, in some aspects, process 1800 may include additional blocks, fewer blocks, different blocks, or differently arranged blocks than those depicted in FIG. 18. Additionally, or alternatively, two or more of the blocks of process 1800 may be performed in parallel.

FIG. 19 is a diagram of an example apparatus 1900 for wireless communication, in accordance with the present disclosure. The apparatus 1900 may be a wireless communication device, or a wireless communication device may include the apparatus 1900. In some aspects, the apparatus 1900 includes a reception component 1902, a transmission component 1904, and/or a communication manager 1906, which may be in communication with one another (for example, via one or more buses and/or one or more other components). In some aspects, the communication manager 1906 is the communication manager 150 described in connection with FIG. 1. As shown, the apparatus 1900 may communicate with another apparatus 1908, such as a UE or a network node (such as a CU, a DU, an RU, or a base station), using the reception component 1902 and the transmission component 1904. The communication manager 1906 may be included in, or implemented via, a processing system (for example, the processing system 140 described in connection with FIG. 1) of the wireless communication device.

In some aspects, the apparatus 1900 may be configured to perform one or more operations described herein in connection with FIGS. 8-14. Additionally, or alternatively, the apparatus 1900 may be configured to perform one or more processes described herein, such as process 1500 of FIG. 15, process 1600 of FIG. 16, process 1700 of FIG. 17, or a combination thereof. In some aspects, the apparatus 1900 and/or one or more components shown in FIG. 19 may include one or more components of the wireless communication device described in connection with FIG. 1. Additionally, or alternatively, one or more components shown in FIG. 19 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 1902 may receive communications, such as reference signals, control information, data communications, or a combination thereof, from the apparatus 1908. The reception component 1902 may provide received communications to one or more other components of the apparatus 1900. In some aspects, the reception component 1902 may perform signal processing on the received communications, and may provide the processed signals to the one or more other components of the apparatus 1900. In some aspects, the reception component 1902 may include one or more components of the wireless communication device described above in connection with FIG. 1, such as a radio, one or more RF chains, one or more transceivers, or one or more modems, each of which may in turn be coupled with one or more antennas of the wireless communication device.

The transmission component 1904 may transmit communications, such as reference signals, control information, data communications, or a combination thereof, to the apparatus 1908. In some aspects, one or more other components of the apparatus 1900 may generate communications and may provide the generated communications to the transmission component 1904 for transmission to the apparatus 1908. In some aspects, the transmission component 1904 may perform signal processing on the generated communications, and may transmit the processed signals to the apparatus 1908. In some aspects, the transmission component 1904 may include one or more components of the wireless communication device described above in connection with FIG. 1, such as a radio, one or more RF chains, one or more transceivers, or one or more modems, each of which may in turn be coupled with one or more antennas of the wireless communication device described in connection with FIG. 1. In some aspects, the transmission component 1904 may be co-located with the reception component 1902.

The communication manager 1906 may support operations of the reception component 1902 and/or the transmission component 1904. For example, the communication manager 1906 may receive information associated with configuring reception of communications by the reception component 1902 and/or transmission of communications by the transmission component 1904. Additionally, or alternatively, the communication manager 1906 may generate and/or provide control information to the reception component 1902 and/or the transmission component 1904 to control reception and/or transmission of communications.

The transmission component 1904 may transmit, to a second wireless communication device, coordination information associated with receiving a multi-layer communication from a network node via multiple transmissive surfaces. The reception component 1902 may receive the multi-layer communication from the network node via the multiple transmissive surfaces.

The communication manager 1906 may measure a reference signal, wherein a cross transmissive surface interference associated with the multiple transmissive surfaces is determined based at least in part on the reference signal.

The communication manager 1906 may forward, via a sidelink communication channel, the multi-layer communication to the second wireless communication device.

The reception component 1902 may receive, via a sidelink communication channel, a communication from the second wireless communication device.

The communication manager 1906 may forward the communication to the network node via a transmissive surface of the multiple transmissive surfaces.

The reception component 1902 may receive a control message from the network node via one or more of the multiple transmissive surfaces.

The communication manager 1906 may forward, via a sidelink communication channel, the control message to the second wireless communication device.

The transmission component 1904 may transmit, to the network node, an indication of a quantity of uncorrelated streams that can be communicated via the multiple transmissive surfaces.

The transmission component 1904 may transmit, to a network node, information indicating an availability of multiple antenna modules for communicating uncorrelated streams via multiple transmissive surfaces. The reception component 1902 may receive a multi-layer communication from the network node via the multiple transmissive surfaces.

The transmission component 1904 may transmit, to another wireless communication device, coordination information associated with receiving the multi-layer communication from the network node via the multiple transmissive surfaces.

The communication manager 1906 may communicate a reference signal, wherein a cross transmissive surface interference associated with the multiple transmissive surfaces is determined based at least in part on the reference signal.

The communication manager 1906 may forward, via a sidelink communication channel, the multi-layer communication to another wireless communication device.

The reception component 1902 may receive, via a sidelink communication channel, a communication from another wireless communication device.

The communication manager 1906 may forward the communication to the network node via a transmissive surface of the multiple transmissive surfaces.

The reception component 1902 may receive a control message from the network node via one or more of the multiple transmissive surfaces.

The communication manager 1906 may forward, via a sidelink communication channel, the control message to another wireless communication device.

The transmission component 1904 may transmit, to the network node, an indication of a quantity of uncorrelated streams that can be communicated via the multiple transmissive surfaces.

The transmission component 1904 may transmit, to a network node, information indicating a rank denoting a quantity of uncorrelated streams that can be communicated via multiple transmissive surfaces. The reception component 1902 may receive a multi-layer communication from the network node via the multiple transmissive surfaces.

The transmission component 1904 may transmit, to another wireless communication device, coordination information associated with receiving the multi-layer communication from the network node via the multiple transmissive surfaces.

The communication manager 1906 may measure or process a reference signal, wherein a cross transmissive surface interference associated with the multiple transmissive surfaces is determined based at least in part on the reference signal.

The communication manager 1906 may forward, via a sidelink communication channel, the multi-layer communication to another wireless communication device.

The reception component 1902 may receive, via a sidelink communication channel, a communication from another wireless communication device.

The communication manager 1906 may forward the communication to the network node via a transmissive surface of the multiple transmissive surfaces.

The reception component 1902 may receive a control message from the network node via one or more of the multiple transmissive surfaces.

The communication manager 1906 may forward, via a sidelink communication channel, the control message to another wireless communication device.

The number and arrangement of components shown in FIG. 19 are provided as an example. In practice, there may be additional components, fewer components, different components, or differently arranged components than those shown in FIG. 19. Furthermore, two or more components shown in FIG. 19 may be implemented within a single component, or a single component shown in FIG. 19 may be implemented as multiple, distributed components. Additionally, or alternatively, a set of (one or more) components shown in FIG. 19 may perform one or more functions described as being performed by another set of components shown in FIG. 19.

FIG. 20 is a diagram of an example apparatus 2000 for wireless communication, in accordance with the present disclosure. The apparatus 2000 may be a network node, or a network node may include the apparatus 2000. In some aspects, the apparatus 2000 includes a reception component 2002, a transmission component 2004, and/or a communication manager 2006, which may be in communication with one another (for example, via one or more buses and/or one or more other components). In some aspects, the communication manager 2006 is the communication manager 155 described in connection with FIG. 1. As shown, the apparatus 2000 may communicate with another apparatus 2008, such as a UE or a network node (such as a CU, a DU, an RU, or a base station), using the reception component 2002 and the transmission component 2004. The communication manager 2006 may be included in, or implemented via, a processing system (for example, the processing system 145 described in connection with FIG. 1) of the network node.

In some aspects, the apparatus 2000 may be configured to perform one or more operations described herein in connection with FIGS. 8-14. Additionally, or alternatively, the apparatus 2000 may be configured to perform one or more processes described herein, such as process 1800 of FIG. 18. In some aspects, the apparatus 2000 and/or one or more components shown in FIG. 20 may include one or more components of the network node described in connection with FIG. 1. Additionally, or alternatively, one or more components shown in FIG. 20 may be implemented within one or more components described in connection with FIG. 1. Additionally, or alternatively, one or more components of the set of components may be implemented at least in part as software stored in one or more memories. For example, a component (or a portion of a component) may be implemented as instructions or code stored in a non-transitory computer-readable medium and executable by one or more controllers or one or more processors to perform the functions or operations of the component.

The reception component 2002 may receive communications, such as reference signals, control information, data communications, or a combination thereof, from the apparatus 2008. The reception component 2002 may provide received communications to one or more other components of the apparatus 2000. In some aspects, the reception component 2002 may perform signal processing on the received communications, and may provide the processed signals to the one or more other components of the apparatus 2000. In some aspects, the reception component 2002 may include one or more components of the network node described above in connection with FIG. 1, such as a radio, one or more RF chains, one or more transceivers, or one or more modems, each of which may in turn be coupled with one or more antennas of the network node. In some aspects, the reception component 2002 and/or the transmission component 2004 may include or may be included in a network interface. The network interface may be configured to obtain and/or output signals for the apparatus 2000 via one or more communications links, such as a backhaul link, a midhaul link, and/or a fronthaul link.

The transmission component 2004 may transmit communications, such as reference signals, control information, data communications, or a combination thereof, to the apparatus 2008. In some aspects, one or more other components of the apparatus 2000 may generate communications and may provide the generated communications to the transmission component 2004 for transmission to the apparatus 2008. In some aspects, the transmission component 2004 may perform signal processing on the generated communications, and may transmit the processed signals to the apparatus 2008. In some aspects, the transmission component 2004 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 2004 may be co-located with the reception component 2002.

The communication manager 2006 may support operations of the reception component 2002 and/or the transmission component 2004. For example, the communication manager 2006 may receive information associated with configuring reception of communications by the reception component 2002 and/or transmission of communications by the transmission component 2004. Additionally, or alternatively, the communication manager 2006 may generate and/or provide control information to the reception component 2002 and/or the transmission component 2004 to control reception and/or transmission of communications.

The reception component 2002 may receive an indication of a location of a UE within a facility (e.g., a building, a car, a train, or the like). The transmission component 2004 may transmit a multi-layer communication to the UE via a transmissive surface on the facility based at least in part on the location of the UE, wherein the transmissive surface is patterned with a phase profile to achieve aperture magnification.

The number and arrangement of components shown in FIG. 20 are provided as an example. In practice, there may be additional components, fewer components, different components, or differently arranged components than those shown in FIG. 20. Furthermore, two or more components shown in FIG. 20 may be implemented within a single component, or a single component shown in FIG. 20 may be implemented as multiple, distributed components. Additionally, or alternatively, a set of (one or more) components shown in FIG. 20 may perform one or more functions described as being performed by another set of components shown in FIG. 20.

The following provides an overview of some Aspects of the present disclosure:

Aspect 1: A method of wireless communication performed by a first wireless communication device, comprising: transmitting, to a second wireless communication device, coordination information associated with receiving a multi-layer communication from a network node via multiple transmissive surfaces; and receiving the multi-layer communication from the network node via the multiple transmissive surfaces.

Aspect 2: The method of Aspect 1, wherein the first wireless communication device comprises a first UE and the second wireless communication device comprises a second UE.

Aspect 3: The method of any of Aspects 1-2, wherein the first wireless communication device comprises a first user equipment and the second wireless communication device comprises a customer premises equipment.

Aspect 4: The method of any of Aspects 1-3, wherein the first wireless communication device comprises a first CPE and the second wireless communication device comprises a second CPE.

Aspect 5: The method of any of Aspects 1-4, wherein the first wireless communication device comprises a customer premises equipment and the second wireless communication device comprises a user equipment.

Aspect 6: The method of any of Aspects 1-5, wherein the coordination information indicates a TCI state associated with the multi-layer communication.

Aspect 7: The method of Aspect 6, wherein the TCI state corresponds to an LoS path via a transmissive surface, of the multiple transmissive surfaces, or a dominant non-LoS path via the transmissive surface.

Aspect 8: The method of any of Aspects 1-7, wherein the coordination information includes control information, beam attribute information, configuration information, or a combination thereof.

Aspect 9: The method of any of Aspects 1-8, wherein the coordination information is transmitted via a sidelink communication channel.

Aspect 10: The method of any of Aspects 1-9, further comprising: measuring or processing a reference signal, wherein a cross transmissive surface interference associated with the multiple transmissive surfaces is determined based at least in part on the reference signal.

Aspect 11: The method of Aspect 10, wherein the reference signal comprises a CSI reference signal, a reference signal transmitted via an interference measurement resource, or a combination thereof.

Aspect 12: The method of any of Aspects 1-11, wherein a distance between the multiple transmissive surfaces enables multi-layer spatial division multiplex communications between the first wireless communication device and the network node.

Aspect 13: The method of any of Aspects 1-12, wherein the first wireless communication device and the second wireless communication device are served using a same radio frequency beam.

Aspect 14: The method of any of Aspects 1-13, wherein a distance between the multiple transmissive surfaces is based at least in part on a distance between a location of the multiple transmissive surfaces and a location of the network node.

Aspect 15: The method of Aspect 14, wherein the distance between the multiple transmissive surfaces is further based at least in part on a quantity of elements included in an antenna array of the network node.

Aspect 16: The method of any of Aspects 1-15, wherein the multiple transmissive surfaces are configured to direct the multi-layer communication toward one or more other wireless communication devices and the first wireless communication device receives the multi-layer communication from the one or more other wireless communication devices.

Aspect 17: The method of Aspect 16, wherein the one or more other wireless communication devices comprise a user equipment, a relay, a customer premises equipment, or a combination thereof.

Aspect 18: The method of any of Aspects 1-17, further comprising: forwarding, via a sidelink communication channel, the multi-layer communication to the second wireless communication device.

Aspect 19: The method of any of Aspects 1-18, wherein the multi-layer communication is received from a plurality of network nodes.

Aspect 20: The method of any of Aspects 1-19, further comprising: receiving, via a sidelink communication channel, a communication from the second wireless communication device; and forwarding the communication to the network node via a transmissive surface of the multiple transmissive surfaces.

Aspect 21: The method of Aspect 20, wherein the communication comprises a control message.

Aspect 22: The method of any of Aspects 1-21, further comprising: receiving a control message from the network node via one or more of the multiple transmissive surfaces; and forwarding, via a sidelink communication channel, the control message to the second wireless communication device.

Aspect 23: The method of any of Aspects 1-22, wherein the first wireless communication device comprises multiple antenna modules, the method further comprising: transmitting, to the network node, an indication of an availability of the multiple antenna modules for communicating uncorrelated streams via the multiple transmissive surfaces.

Aspect 24: The method of Aspect 23, wherein the indication is transmitted based at least in part on determining a distance between the network node and the multiple transmissive surfaces, a distance between the first wireless communication device and the multiple transmissive surfaces, a distance between adjacent transmissive surfaces of the multiple transmissive surfaces, or a combination thereof.

Aspect 25: The method of any of Aspects 1-24, wherein a transmissive surface, of the multiple transmissive surfaces, is patterned with a phase profile to achieve aperture magnification.

Aspect 26: The method of Aspect 25, wherein the aperture magnification is achieved based at least in part on a beam-focusing pattern that assumes a source at a first reference position associated with an antenna array of the network node and a resource at a second reference position associated with an antenna array of the first wireless communication device.

Aspect 27: The method of Aspect 26, wherein the first reference position comprises a center of the antenna array of the network node, the second reference position comprises a center of the antenna array of the first wireless communication device, or a combination thereof.

Aspect 28: The method of Aspect 25, wherein the transmissive surface is patterned to compensate for curvatures on incident and refracted wavefronts associated with the transmissive surface.

Aspect 29: The method of any of Aspects 1-28, further comprising: transmitting, to the network node, an indication of a quantity of uncorrelated streams that can be communicated via the multiple transmissive surfaces.

Aspect 30: A method of wireless communication performed by a wireless communication device, comprising: transmitting, to a network node, information indicating an availability of multiple antenna modules for communicating uncorrelated streams via multiple transmissive surfaces; and receiving a multi-layer communication from the network node via the multiple transmissive surfaces.

Aspect 31: The method of Aspect 30, further comprising: transmitting, to another wireless communication device, coordination information associated with receiving the multi-layer communication from the network node via the multiple transmissive surfaces.

Aspect 32: The method of Aspect 31, wherein the wireless communication device comprises a first user equipment and the other wireless communication device comprises a customer premises equipment.

Aspect 33: The method of Aspect 31, wherein the wireless communication device comprises a first CPE and the other wireless communication device comprises a second CPE.

Aspect 34: The method of Aspect 31, wherein the wireless communication device comprises a customer premises equipment and the other wireless communication device comprises a user equipment.

Aspect 35: The method of Aspect 31, wherein the coordination information indicates a TCI state associated with the multi-layer communication.

Aspect 36: The method of Aspect 35, wherein the TCI state corresponds to an LoS path via a transmissive surface, of the multiple transmissive surfaces, or a dominant non-LoS path via the transmissive surface.

Aspect 37: The method of Aspect 31, wherein the coordination information includes control information, beam attribute information, configuration information, or a combination thereof.

Aspect 38: The method of Aspect 31, wherein the coordination information is transmitted via a sidelink communication channel.

Aspect 39: The method of Aspect 31, wherein the wireless communication device and the other wireless communication device are served using a same radio frequency beam.

Aspect 40: The method of any of Aspects 30-39, further comprising: measuring or processing a reference signal, wherein a cross transmissive surface interference associated with the multiple transmissive surfaces is determined based at least in part on the reference signal.

Aspect 41: The method of Aspect 40, wherein the reference signal comprises a CSI reference signal, a reference signal transmitted on or via an interference measurement resource, or a combination thereof.

Aspect 42: The method of any of Aspects 30-41, wherein a distance between the multiple transmissive surfaces enables multi-layer spatial division multiplex communications between the first wireless communication device and the network node.

Aspect 43: The method of any of Aspects 30-42, wherein a distance between the multiple transmissive surfaces is based at least in part on a distance between a location of the multiple transmissive surfaces and a location of the network node.

Aspect 44: The method of Aspect 43, wherein the distance between the multiple transmissive surfaces is further based at least in part on a quantity of elements included in an antenna array of the network node.

Aspect 45: The method of any of Aspects 30-44, wherein the multiple transmissive surfaces are configured to direct the multi-layer communication toward one or more other wireless communication devices and the wireless communication device receives the multi-layer communication from the one or more other wireless communication devices.

Aspect 46: The method of Aspect 45, wherein the one or more other wireless communication devices comprise a user equipment, a relay, a customer premises equipment, or a combination thereof.

Aspect 47: The method of any of Aspects 30-46, further comprising: forwarding, via a sidelink communication channel, the multi-layer communication to another wireless communication device.

Aspect 48: The method of any of Aspects 30-47, wherein the multi-layer communication is received from a plurality of network nodes.

Aspect 49: The method of any of Aspects 30-48, further comprising: receiving, via a sidelink communication channel, a communication from another wireless communication device; and forwarding the communication to the network node via a transmissive surface of the multiple transmissive surfaces.

Aspect 50: The method of Aspect 49, wherein the communication comprises a control message.

Aspect 51: The method of any of Aspects 30-50, further comprising: receiving a control message from the network node via one or more of the multiple transmissive surfaces; and forwarding, via a sidelink communication channel, the control message to another wireless communication device.

Aspect 52: The method of any of Aspects 30-51, wherein the information indicating the availability of the multiple antenna modules for communicating the uncorrelated streams via the multiple transmissive surfaces is transmitted based at least in part on determining a distance between the network node and the the multiple transmissive surfaces, a distance between the wireless communication device and the multiple transmissive surfaces, a distance between adjacent transmissive surfaces of the multiple transmissive surfaces, or a combination thereof.

Aspect 53: The method of any of Aspects 30-52, wherein a transmissive surface, of the multiple transmissive surfaces, is patterned with a phase profile to achieve aperture magnification.

Aspect 54: The method of Aspect 53, wherein the aperture magnification is achieved based at least in part on a beam-focusing pattern that assumes a source at a first reference position associated with an antenna array of the network node and a receiver at a second reference position associated with an antenna array of the wireless communication device.

Aspect 55: The method of Aspect 54, wherein the first reference position comprises a center of the antenna array of the network node, the second reference position comprises a center of the antenna array of the wireless communication device, or a combination thereof.

Aspect 56: The method of Aspect 53, wherein the transmissive surface is patterned to compensate for curvatures on incident and refracted wavefronts associated with the transmissive surface.

Aspect 57: The method of any of Aspects 30-56, further comprising: transmitting, to the network node, an indication of a quantity of uncorrelated streams that can be communicated via the multiple transmissive surfaces.

Aspect 58: A method of wireless communication performed by a wireless communication device, comprising: transmitting, to a network node, information indicating a rank denoting a quantity of uncorrelated streams that can be communicated via multiple transmissive surfaces; and receiving a multi-layer communication from the network node via the multiple transmissive surfaces.

Aspect 59: The method of Aspect 58, further comprising: transmitting, to another wireless communication device, coordination information associated with receiving the multi-layer communication from the network node via the multiple transmissive surfaces.

Aspect 60: The method of Aspect 59, wherein the wireless communication device comprises a first user equipment and the other wireless communication device comprises a customer premises equipment.

Aspect 61: The method of Aspect 59, wherein the wireless communication device comprises a first CPE and the other wireless communication device comprises a second CPE.

Aspect 62: The method of Aspect 59, wherein the wireless communication device comprises a customer premises equipment and the other wireless communication device comprises a user equipment.

Aspect 63: The method of Aspect 59, wherein the coordination information indicates a TCI state associated with the multi-layer communication.

Aspect 64: The method of Aspect 63, wherein the TCI state corresponds to an LoS path via a transmissive surface, of the multiple transmissive surfaces, or a dominant non-LoS path via the transmissive surface.

Aspect 65: The method of Aspect 59, wherein the coordination information includes control information, beam attribute information, configuration information, or a combination thereof.

Aspect 66: The method of Aspect 59, wherein the coordination information is transmitted via a sidelink communication channel.

Aspect 67: The method of Aspect 59, wherein the wireless communication device and the other wireless communication device are served using a same radio frequency beam.

Aspect 68: The method of any of Aspects 58-67, further comprising: measuring a reference signal, wherein a cross transmissive surface interference associated with the multiple transmissive surfaces is determined based at least in part on the reference signal.

Aspect 69: The method of Aspect 68, wherein the reference signal comprises a CSI reference signal, a reference signal transmitted via an interference measurement resource, or a combination thereof.

Aspect 70: The method of any of Aspects 58-69, wherein a distance between the multiple transmissive surfaces enables multi-layer spatial division multiplex communications between the first wireless communication device and the network node.

Aspect 71: The method of any of Aspects 58-70, wherein a distance between the multiple transmissive surfaces is based at least in part on a distance between a location of the multiple transmissive surfaces and a location of the network node.

Aspect 72: The method of Aspect 71, wherein the distance between the multiple transmissive surfaces is further based at least in part on a quantity of elements included in an antenna array of the network node.

Aspect 73: The method of any of Aspects 58-72, wherein the multiple transmissive surfaces are configured to direct the multi-layer communication toward one or more other wireless communication devices and the wireless communication device receives the multi-layer communication from the one or more other wireless communication devices.

Aspect 74: The method of Aspect 73, wherein the one or more other wireless communication devices comprise a user equipment, a relay, a customer premises equipment, or a combination thereof.

Aspect 75: The method of any of Aspects 58-74, further comprising: forwarding, via a sidelink communication channel, the multi-layer communication to another wireless communication device.

Aspect 76: The method of any of Aspects 58-75, wherein the multi-layer communication is received from a plurality of network nodes.

Aspect 77: The method of any of Aspects 58-76, further comprising: receiving, via a sidelink communication channel, a communication from another wireless communication device; and forwarding the communication to the network node via a transmissive surface of the multiple transmissive surfaces.

Aspect 78: The method of Aspect 77, wherein the communication comprises a control message.

Aspect 79: The method of any of Aspects 58-78, further comprising: receiving a control message from the network node via one or more of the multiple transmissive surfaces; and forwarding, via a sidelink communication channel, the control message to another wireless communication device.

Aspect 80: The method of any of Aspects 58-79, wherein the wireless communication device comprises multiple antenna modules, the method further comprising: transmitting, to the network node, an indication of an availability of the multiple antenna modules for communicating uncorrelated streams via the multiple transmissive surfaces.

Aspect 81: The method of Aspect 80, wherein the indication is transmitted based at least in part on determining a distance between the network node and the multiple transmissive surfaces, a distance between the wireless communication device and the multiple transmissive surfaces, a distance between adjacent transmissive surfaces of the multiple transmissive surfaces, or a combination thereof.

Aspect 82: The method of any of Aspects 58-81, wherein a transmissive surface, of the multiple transmissive surfaces, is patterned with a phase profile to achieve aperture magnification.

Aspect 83: The method of Aspect 82, wherein the aperture magnification is achieved based at least in part on a beam-focusing pattern that assumes a source at a first reference position associated with an antenna array of the network node and a receiver at a second reference position associated with an antenna array of the wireless communication device.

Aspect 84: The method of Aspect 83, wherein the first reference position comprises a center of the antenna array of the network node, the second reference position comprises a center of the antenna array of the wireless communication device, or a combination thereof.

Aspect 85: The method of Aspect 82, wherein the transmissive surface is patterned to compensate for curvatures on incident and refracted wavefronts associated with the transmissive surface.

Aspect 86: A method of wireless communication performed by a network node, comprising: receiving an indication of a location of a UE within a facility; and transmitting a multi-layer communication to the UE via a transmissive surface on the facility based at least in part on the location of the UE, wherein the transmissive surface is patterned with a phase profile to achieve aperture magnification.

Aspect 87: The method of Aspect 86, wherein the transmissive surface is patterned to compensate for curvatures on incident and refracted wavefronts associated with the transmissive surface.

Aspect 88: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-87.

Aspect 89: An apparatus for wireless communication at a device, the apparatus comprising one or more memories and one or more processors coupled to the one or more memories, the one or more processors configured to cause the device to perform the method of one or more of Aspects 1-87.

Aspect 90: An apparatus for wireless communication, the apparatus comprising at least one means for performing the method of one or more of Aspects 1-87.

Aspect 91: A non-transitory computer-readable medium storing code for wireless communication, the code comprising instructions executable by one or more processors to perform the method of one or more of Aspects 1-87.

Aspect 92: A non-transitory computer-readable medium storing a set of instructions for wireless communication, the set of instructions comprising one or more instructions that, when executed by one or more processors of a device, cause the device to perform the method of one or more of Aspects 1-87.

Aspect 93: A device for wireless communication, the device comprising a processing system that includes one or more processors and one or more memories coupled with the one or more processors, the processing system configured to cause the device to perform the method of one or more of Aspects 1-87.

Aspect 94: An apparatus for wireless communication at a device, the apparatus comprising one or more memories and one or more processors coupled to the one or more memories, the one or more processors individually or collectively configured to cause the device to perform the method of one or more of Aspects 1-87.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (for example, an element “having” A may also have B). Also, as used herein, the term “or” is intended to be inclusive when used in a series and may be used interchangeably with “and/or,” unless explicitly stated otherwise (for example, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (for example, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. A first wireless communication device for wireless communication, comprising:
one or more memories; and
one or more processors, coupled to the one or more memories, configured to cause the first wireless communication device to:
transmit, to a second wireless communication device, coordination information associated with receiving a multi-layer communication from a network node via multiple transmissive surfaces; and
receive the multi-layer communication from the network node via the multiple transmissive surfaces.

2. The first wireless communication device of claim 1, wherein the first wireless communication device comprises a first user equipment (UE) and the second wireless communication device comprises a second UE.

3. The first wireless communication device of claim 1, wherein the first wireless communication device comprises a first user equipment and the second wireless communication device comprises a customer premises equipment.

4. The first wireless communication device of claim 1, wherein the first wireless communication device comprises a first customer premises equipment (CPE) and the second wireless communication device comprises a second CPE.

5. The first wireless communication device of claim 1, wherein the first wireless communication device comprises a customer premises equipment and the second wireless communication device comprises a user equipment.

6. The first wireless communication device of claim 1, wherein the coordination information indicates a transmission configuration indicator (TCI) state associated with the multi-layer communication.

7. The first wireless communication device of claim 6, wherein the TCI state corresponds to a line-of-sight (LoS) path via a transmissive surface, of the multiple transmissive surfaces, or a dominant non-LoS path via the transmissive surface.

8. The first wireless communication device of claim 1, wherein the one or more processors are further configured to cause the first wireless communication device to:
measure or process a reference signal, wherein a cross transmissive surface interference associated with the multiple transmissive surfaces is determined based at least in part on the reference signal.

9. The first wireless communication device of claim 1, wherein a distance between the multiple transmissive surfaces is based at least in part on a distance between a location of the multiple transmissive surfaces and a location of the network node.

10. The first wireless communication device of claim 9, wherein the distance between the multiple transmissive surfaces is further based at least in part on a quantity of elements included in an antenna array of the network node.

11. The first wireless communication device of claim 1, wherein the multi-layer communication is received from a plurality of network nodes.

12. The first wireless communication device of claim 1, wherein the one or more processors are further configured to cause the first wireless communication device to:
receive a control message from the network node via one or more of the multiple transmissive surfaces; and
forward, via a sidelink communication channel, the control message to the second wireless communication device.

13. The first wireless communication device of claim 1, wherein the first wireless communication device comprises multiple antenna modules, wherein the one or more processors are further configured to cause the first wireless communication device to:
transmit, to the network node, an indication of an availability of the multiple antenna modules for communicating uncorrelated streams via the multiple transmissive surfaces.

14. The first wireless communication device of claim 1, wherein a transmissive surface, of the multiple transmissive surfaces, is patterned with a phase profile to achieve aperture magnification.

15. The first wireless communication device of claim 14, wherein the aperture magnification is achieved based at least in part on a beam-focusing pattern that assumes a source at a first reference position associated with an antenna array of the network node and a receiver at a second reference position associated with an antenna array of the first wireless communication device.

16. The first wireless communication device of claim 15, wherein the first reference position comprises a center of the antenna array of the network node, the second reference position comprises a center of the antenna array of the first wireless communication device, or a combination thereof.

17. The first wireless communication device of claim 16, wherein the transmissive surface is patterned to compensate for curvatures on incident and refracted wavefronts associated with the transmissive surface.

18. The first wireless communication device of claim 1, wherein the one or more processors are further configured to cause the first wireless communication device to:
transmit, to the network node, an indication of a quantity of uncorrelated streams that can be communicated via the multiple transmissive surfaces.

19. A wireless communication device for wireless communication, comprising:
one or more memories; and
one or more processors, coupled to the one or more memories, configured to cause the wireless communication device to:
transmit, to a network node, information indicating an availability of multiple antenna modules for communicating uncorrelated streams via multiple transmissive surfaces; and
receive a multi-layer communication from the network node via the multiple transmissive surfaces.

20. A wireless communication device for wireless communication, comprising:
one or more memories; and
one or more processors, coupled to the one or more memories, configured to cause the wireless communication device to:
transmit, to a network node, information indicating a rank denoting a quantity of uncorrelated streams that can be communicated via multiple transmissive surfaces; and
receive a multi-layer communication from the network node via the multiple transmissive surfaces.
